(19) United States
(12) Patent Application Publication
(10) Pub. No.: US 2023/0385103 A1
(43) Pub. Date: Nov. 30, 2023

(54) INTELLIGENT DATA CONVERSION IN DATAFLOW AND DATA PARALLEL COMPUTING SYSTEMS

(71) Applicant: SambaNova Systems, Inc., Palo Alto, CA (US)

(72) Inventors: Qi ZHENG, Fremont, CA (US); Ravinder KUMAR, Fremont, CA (US); Arnav GOEL, San Jose, CA (US); Po-Yu WU, Palo Alto, CA (US); Arjun SABNIS, San Francisco, CA (US); Joshua Earle POLZIN, Palo Alto, CA (US)

(73) Assignee: SambaNova Systems, Inc., Palo Alto, CA (US)

(21) Appl. No.: 18/200,210

(22) Filed: May 22, 2023

Related U.S. Application Data
(60) Provisional application No. 63/388,630, filed on Jul. 12, 2022.
(60) Provisional application No. 63/346,031, filed on May 26, 2022.

(51) Int. Cl. G06F 9/48; G06F 9/38

(52) U.S. Cl. CPC G06F 9/4881; G06F 9/3877

(57) ABSTRACT

In a method an Intelligent Data Conversion (IDC) engine of a dataflow system detects a stage transition of a dataflow application executing on the dataflow system. In response, the IDC engine determines that data among stage data of the application has a first Stage Data Format (SDF). The IDC engine determines that a first processing unit of the dataflow system can process data having a second SDF and determines a data conversion to convert data among the stage data to have the second SDF. The IDC engine also determines a second processing unit, of the dataflow system to perform the data conversion and dispatches the second processing unit to perform the data conversion. The dataflow computing system can include a runtime processor and the IDC engine can interact with the runtime processor to detect the stage transition and/or dispatch the first processing unit.

### INCORPORATIONS

The following are incorporated by reference for all purposes as if fully set forth herein:
Prabhakar et al., “Plasticine: A Reconfigurable Architecture for Parallel Patterns,” ISCA '17, Jun. 24-28, 2017, Toronto, ON, Canada;
U.S. Nonprovisional patent application Ser. No. 16/239,252, filed Jan. 3, 2019, entitled “VIRTUALIZATION OF A RECONFIGURABLE DATA PROCESSOR,” (Attorney Docket No. SBNV 1000-1);
U.S. Nonprovisional patent application Ser. No. 16/572,516, filed Sep. 16, 2019, entitled “EFFICIENT EXECUTION OF OPERATION UNIT GRAPHS ON RECONFIGURABLE ARCHITECTURES BASED ON USER SPECIFICATION,” (Attorney Docket No. SBNV 1009-2);
U.S. Nonprovisional patent application Ser. No. 16/922,975, filed Jul. 7, 2020, entitled “RUNTIME VIRTUALIZATION OF RECONFIGURABLE DATA FLOW RESOURCES,” (Attorney Docket No. SBNV 1026-1);
U.S. Nonprovisional patent application Ser. No. 17/214,768, filed Mar. 26, 2021, entitled “RESOURCE ALLOCATION FOR RECONFIGURABLE PROCESSORS,” (Attorney Docket No. SBNV 1028-1).

### PRIORITY BENEFIT CLAIM

This application claims the benefit of U.S. Provisional Patent Application No. 63/346,031 filed May 26, 2022, which is incorporated by reference herein in its entirety.

This application further claims the benefit of U.S. Provisional Patent Application No. 63/388,630 filed Jul. 12, 2022, which is incorporated by reference herein in its entirety.

### FIELD OF THE TECHNOLOGY

The technology disclosed relates to dataflow computing computers and computing systems for executing dataflow computing applications. In particular, the technology disclosed relates to executing dataflow computing applications using reconfigurable processors, such as coarse-grain reconfigurable architectures (CGRAs), and dataflow computing systems comprising heterogeneous processing elements. The technology disclosed further relates to managing application dataflow between application pipeline stages.

### BACKGROUND

The present disclosure relates to computing systems for performing dataflow computing applications, such as knowledge based systems, reasoning systems, knowledge acquisition systems, systems for reasoning with uncertainty (e.g., fuzzy logic systems), adaptive systems, machine learning systems, and artificial neural networks. The present disclosure further relates to dataflow computing systems using reconfigurable processing architectures, such as computing systems comprising Coarse-Grained Reconfigurable Architectures (CGRAs), to execute such applications. Additionally, the present disclosure relates to converting and/or transferring data during execution of such applications by a dataflow computing system.

### BRIEF DESCRIPTION OF THE DRAWINGS

The drawings included in the present disclosure are incorporated into, and form part of, the specification. They illustrate implementations of the present disclosure (hereinafter, “the disclosure) and, along with the description, serve to explain the principles of the disclosure. The drawings are intended to be only illustrative of certain implementations and are not intended to limit the disclosure.

FIG. 1 illustrates an example Coarse Grain Computing System, according to aspects of the disclosure.

FIG. 2A illustrates an example application having multiple stages, according to aspects of the disclosure.

FIG. 2B illustrates an example of intelligent data conversion in an enhanced staging reconfigurable dataflow system (CGRS), according to aspects of the disclosure.

FIG. 3A illustrates an example CGRS, according to aspects of the disclosure.

FIG. 3B illustrates an alternative example CGRS, according to aspects of the disclosure.

FIG. 4 illustrates an example method for performing intelligent data conversion between stages of application execution, according to aspects of the disclosure.

FIG. 5 illustrates an example node of a reconfigurable data flow system, according to aspects of the disclosure.

FIG. 6 illustrates an example transfer channel, according to aspects of the disclosure.

FIG. 7 illustrates an example multi-node data flow system, according to aspects of the disclosure.

FIG. 8 illustrates an example method to move application data and/or results among components of a computing system, according to aspects of the disclosure.

FIG. 9 illustrates an example method to transfer application data and/or results utilizing multiple transfer channels of a computing system, according to aspects of the disclosure.

### SUMMARY

A method comprises an Intelligent Data Conversion Engine (IDC engine), included in a dataflow computing system, detecting a stage transition of a dataflow application executing on the dataflow computing system. The dataflow application comprises a plurality of application stages and the dataflow computing system comprises a plurality of processing units. In the method, in response to detecting the stage transition the IDC engine determine that data among first stage data has a first Stage Data Format (SDF). The first stage data comprises data associated with a first stage among the plurality of application stages. The IDC engine determines that a first processing unit, among the plurality of processing units, can process stage data having a second SDF and determines a data conversion to convert data among the first stage data having the first SDF to have the second SDF. The IDC engine also determines a second processing unit, among the plurality of processing units, to perform the first data conversion and dispatch the second processing unit to perform the first data conversion.

The method can further comprise the IDC engine determining, in response to detecting the stage transition, that the first processing unit can process stage data having a third SDF. The IDC engine can determine a second data conversion to convert the data among the first stage data having the first SDF to have the third SDF, and can determine a third processing unit, among the plurality of processing units, to convert the data among the first stage data having the first SDF to have the third SDF.

The IDC engine can compare a first conversion optimization metric, associated with the second processing unit performing the first data conversion, and a second conversion optimization metric, associated with the third processing unit performing the second data conversion. The IDC engine can dispatch the second processing unit to perform the first data conversion based on comparing the first conversion optimization metric and the second conversion optimization metric.

The method can also include the IDC engine determining that the first data conversion comprises a sequence of intermediate data conversions. The IDC engine determines a third processing unit, among the plurality of processing units, to perform a first intermediate data conversion included in the sequence of intermediate data conversions and a fourth processing unit, among the plurality of processing units, to perform a second intermediate data conversion included in the sequence of intermediate data conversion. The IDC engine also determines a conversion order, comprising an order within the sequence of intermediate data conversions, for the third processing unit to perform the first intermediate data conversion and the fourth processing unit to perform the second intermediate data conversion. The IDC engine dispatches the third processing unit to perform the first intermediate data conversion and the fourth processing unit to perform the second intermediate data conversion according to the conversion order.

A computer program product and a computing system can implement aspects of the method. The computing system can comprise a plurality of processing units to perform the conversions and can execute the dataflow application. In some implementations the computing system can include a runtime processor, and the IDC engine can interact with the runtime processor to detect the stage transition and/or dispatch the processing units. The IDC engine can be included in the runtime processor.

### DETAILED DESCRIPTION

Aspects of the present disclosure (hereinafter, “the disclosure”) relate to computing systems for performing computing applications such as machine learning, “ML” and deep machine learning, “DML” in Artificial Intelligence “AI” applications, image processing, stream processing (e.g., processing of streaming video and/or audio data), natural language processing (NLP), and/or recommendation engines. Applications, such as these examples, can lend themselves to parallel processing of their data, such as by pipelining operations on data and/or executing duplicate operations on different data utilizing parallel processors.

Data of such applications can comprise enormous volumes of data, and the data can be structured, unstructured (e.g., documents, social media content, image, audio, and/or video), or a combination of these. Data of such applications can be represented for computational processing as, for example, scalars, matrices, and/or tensors. Data of such applications can comprise data of varying data types (e.g., integer, or floating point), size (e.g., 8, 16, 32, or 64 bytes), and/or precisions (e.g., half precisions, full precision, and double precision). Such applications can be referred to as “data parallel” or “dataflow” applications, reflecting their parallel processing nature and/or a continuous flow of application data through parallel processing resources.

More particular aspects of the disclosure relate to executing highly parallel applications, such as the foregoing examples, on computing systems utilizing Coarse-Grained Reconfigurable Architectures (CGRAs). Such a computing system is referred to herein as a “Coarse Grain Reconfigurable System (CGRS)” and can include specialized processors, or processing resources, referred to herein as “Coarse Grain Reconfigurable Processors (CGRPs)”. As used herein, the term “CGRP” refers to hardware implementations of processing elements of a computing system based on, or incorporating, a coarse grain reconfigurable architecture. Hardware implementations of CGRPs (e.g., processors, memories, and/or arrays or networks of processors and memories) can comprise one or more Integrated Circuits (ICs), chips, and/or modules.

The disclosure uses the example of a CGRS as representative of a dataflow computing system, and the example of a CGRP as a processing element of a dataflow computing system. However, the disclosure is not limited to dataflow systems comprising a CGRS nor limit to dataflow systems employing CGRPs. It will be appreciated by one of ordinary skill in the art that techniques, devices, and systems within the scope of the disclosure can also apply to dataflow computing systems alternative to CGR systems, and/or dataflow systems utilizing processors such as Central Processing Unit (CPUs), Graphics Processing Units (GPUs), Field Programmable Gate Arrays (FPGAs), Digital Signal Processors (DSPs), and/or specialized Application-Specific Integrated Circuits (ASICs) or Application Specific Instruction-set Processor (ASIP). Implementations can comprise a system, method, or article of manufacture.

Aspects of the disclosure can be appreciated through a discussion of example implementations of the disclosure (hereinafter, for brevity, simply “implementations” except where otherwise qualified or characterized). However, such examples are for purposes of illustrating the disclosure and are not to limit the disclosure to the example implementations described herein, but to encompass all modifications, equivalents, and alternatives falling within the spirit and scope of the disclosure. Thus, the disclosure is not intended to be limited to the implementations shown but is to be accorded the widest scope consistent with the principles and features disclosed herein. Various modifications to the disclosed examples will be readily apparent to those of ordinary skill in the art, and the general principles defined herein may be applied to other implementations of the disclosure without departing from the spirit and scope of the disclosure.

Implementations that are not mutually exclusive are taught and understood to be combinable. One or more features of an implementation can be combined with other implementations. The disclosure in some instances repeats references to these options. However, omission from some implementations of recitations that repeat these options should not be taken as limiting the combinations taught in the preceding sections—these recitations are hereby incorporated forward by reference into each of the following implementations.

Particular expressions of the disclosure will be understood to have particular operative meanings. The phrases “at least one”; “one or more”; and “and/or” are to be understood as open-ended expressions that operate both conjunctively and disjunctively. For example, each of the expressions “at least one of A, B, and C”, “at least one of A, B, or C”, “one or more of A, B, and C”, “one or more of A, B, or C”, and “one or more of A, B, and/or C” means A alone, B alone, C alone, A and B together, A and C together, B and C together, or A, B, and C together. The term “a” or “an” entity refers to one or more of that entity. As such, the terms “a”/“an”, “one or more”, and “at least one” can be used interchangeably herein. The terms “comprising”, “including”, and “having” can be used interchangeably herein. Unless otherwise specified, the use of ordinal adjectives first, second, third, etc., to describe an object, merely refers to different instances or classes of the object and does not imply any ranking or sequence.

As used herein, “incorporated subject matter” refers, collectively, to subject matter disclosed, and/or otherwise encompassed, among the disclosures incorporated herein by reference. For purposes of illustrating the disclosure, but not intended to limit implementations, various terms of the disclosure are drawn from the incorporated subject matter. As used herein, unless expressly stated otherwise, such terms as can be found in the incorporated subject matter have the same meanings, herein, as their meanings in their respective incorporated disclosures.

Aspects of the disclosure can be appreciated through a discussion of example implementations and/or applications of methods and/or systems. However, such examples are for purposes of illustrating the disclosure. It should be understood that the intention is not to limit the disclosure to the example implementations described herein, but to encompass all modifications, equivalents, and alternatives falling within the spirit and scope of the disclosure. Thus, the disclosure is not intended to be limited to the implementations shown but is to be accorded the widest scope consistent with the principles and features disclosed herein. Various modifications to the disclosed examples will be readily appreciated by those of ordinary skill in the art, and the general principles defined herein can be applied to other implementations of the disclosure without departing from the spirit and scope of the disclosure.

The disclosure uses terms and acronyms related to the field of the technology, defined, at least in part, herein as:

AI—artificial intelligence.

AIR—arithmetic or algebraic intermediate representation.

ALN—array-level network.

Application Model—In machine learning applications, “application model” commonly refers to a mathematical representation of a machine learning application. An application model can comprise an application graph and/or textual (e.g., high level, intermediate level, and/or low level programming language) representation. An application model can represent a set of mathematical operators (compute functions of an application) and a flow of data between the operators, and can represent the operators and dataflow graphically and/or textually. As used herein, “application model” or, simply, “model” refers interchangeably to an application itself (e.g., high level programming statements of an application) and a graphical and/or textual representation of the application's compute functions and/or dataflow.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

CGR unit—a circuit that can be configured and reconfigured to locally store data (e.g., a memory unit or a partition memory unit, such as described in Prabhakar), or to execute a programmable function (e.g., a processor or other compute unit, or a partition compute unit such as described in Prabhakar). A CGR unit includes hardwired functionality that performs a limited number of functions used in computation graphs and dataflow graphs. Some implementations include switches to route data among CGR units.

CGR Array—an array of CGR units, coupled with each other through an array-level network (ALN), and coupled with external elements via a top-level network (TLN). In implementations a CGR array can physically implement the nodes and edges of a computation and/or dataflow graph.

CGRP—Coarse-grain reconfigurable processor. As used herein, CGRP refers to a processor, or processing element, utilizing or based on a CGRA. A physical CGRP can comprise one or more integrated circuits, chips, or modules based on, or incorporating, a CGRA. A CGRP can comprise one more computational units, and can further include one or more memories, and/or an array of reconfigurable computational and/or memory units. A CGRP can comprise specialized processing and/or memory elements, such as in the examples of Kumar and Grohoski, and/or can comprise, for example, field programmable gate arrays (FPGAs) and/or graphic processing units (GPUs).

CGR Components—As used herein, “CGR components” refers, collectively, to hardware resources or elements of CGR units, CGR arrays, and CGRP; memories of CGR units/arrays/processors; and, networks and/or I/O interconnections and interface hardware interconnecting CGR units/arrays/processors and/or memories, such as Ethernet networks/interfaces, I/O buses/interfaces, such as PCI-Express buses, InfiniBand buses/interfaces, and/or memory or data buses/interfaces, such as buses of a processor and/or memory fabric, and related interface hardware).

CGR hardware—As used herein, the terms “CGR hardware” and “CGR hardware resources” refer to any individual hardware element, or combination of hardware elements, of CGR components of a CGRS.

CGRS—a computing system comprising CGR units and/or CGRPs. As used herein, CGRS refers to a computing system that is based on, and/or can utilize, reconfigurable computing resources, such as CGR arrays, CGR units, and/or CGRPs, to perform operations of data parallel and/or dataflow applications. U.S. Nonprovisional patent application Ser. No. 16/239,252, “VIRTUALIZATION OF A RECONFIGURABLE DATA PROCESSOR”, to Grohoski, et al, (hereinafter, “Grohoski”), and U.S. Nonprovisional patent application Ser. No. 16/922,975, “RUNTIME VIRTUALIZATION OF RECONFIGURABLE DATA FLOW RESOURCES”, to Kumar, et al, (hereinafter, “Kumar”), both incorporated herein by reference, illustrate example implementations of CGR arrays, CGR units, CGRPs, and CGR systems.

Chip—As used herein, the term “chip” refers to an IC (or, combination of ICs) that can embody elements of a CGRA. A chip can typically be packaged in a chip module (e.g., a single chip module, “SCM” or, alternatively, a multi-chip module, “MCM”).

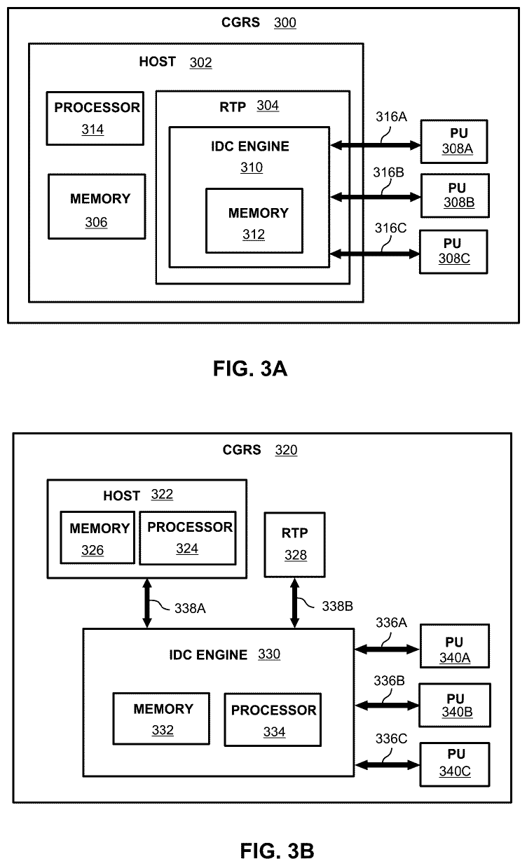

Compiler—a translator that processes statements written in a programming language to machine language instructions for a computer processor. A compiler can include multiple stages to operate in multiple steps. Each stage can create or update an intermediate representation (IR) of the translated statements. Compiler stages are illustrated with reference to FIG. 3.

Computation graph/Graph—As used herein, computation graph refers to a type of directed graph comprising nodes and edges connecting the nodes, to represent a dataflow application. In a neural network application nodes can represent mathematical operations/expressions and edges that indicate dependencies between the operations/expressions. For example, in machine learning (ML) algorithms, input layer nodes can assign variables, output layer nodes can represent algorithm outcomes, and hidden layer nodes can perform operations on the variables. Edges can represent data (e.g., scalars, vectors, tensors) flowing between operations. In addition to dependencies, the computation graph reveals which operations and/or expressions can be executed concurrently.

Dataflow Application—As used herein, for brevity, the term “dataflow application” refers interchangeably to data parallel and dataflow applications. Examples of such applications include machine learning, “ML”, and deep machine learning, “DML” in Artificial Intelligence “AI” applications' neural networks; image processing; stream processing (e.g., processing of streaming video and/or audio data); natural language processing (NLP); recommendation engines; and, other massively parallel computing applications.

Dataflow Graph—a computation graph, or portion of a computation graph, corresponding to operators (application compute functions), data, and flow of data among operators, of a dataflow application that includes one or more loops of operator nodes that can be nested, and wherein nodes can send messages to nodes in earlier (predecessor) layers to control the dataflow between the layers.

Dataflow System—A dataflow system refers to any computing system designed and/or configured to execute dataflow applications, and to execute operations and/or pipelines of operations of dataflow applications, in parallel, such as a CGRS.

IC—integrated circuit—a monolithically integrated circuit, i.e., a single semiconductor die which can be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

Intermediate Representation (IR)—an Intermediate Representation is a representation of an application in an intermediate langue. An IR can incorporate partial compilation results, such as sections (groupings) of a graph or model, pipelines that can be formed within a graph or model, mappings of application functions or graph nodes/edges to hardware resources of a CGRS.

Logical CGR unit—A logical representation of a CGRP or other CGR hardware unit that is physically realizable, but that may not, at a particular time in executing a dataflow application, have been assigned to a physical (e.g., an IC implementation) CGRP or CGR hardware unit.

ML—machine learning.

PEF—processor-executable format—a file format suitable for configuring a CGRP or elements of a CGRP.

Pipeline—a staggered flow of computational operations through a chain of pipeline stages in which the operations can be executed in parallel. In an application graph, a pipeline can comprise a set of operator nodes that can pipeline operations of the graph.

Pipeline Stages—a pipeline can be divided into stages that are coupled with one another as predecessor/successor stage to form a pipe topology.

PNR—place and route—the assignment of logical CGR hardware units and associated processing/operations to physical CGR hardware units in an array, and the configuration of communication paths between the physical CGR hardware units.

TLN—top-level network.

Turning now to more particular aspects of the disclosure, a dataflow application can comprise computations that can be executed concurrently, in parallel, among a plurality of computational elements of a dataflow computing system (hereinafter, for brevity, “dataflow system”) and, additionally or alternatively, can comprise computations that can be execute as pipelines of successive computation stages. As used hereinafter, for brevity, the term “application” refers to a “dataflow application”, and “applications” to “dataflow applications”.

As previously described, dataflow systems can comprise reconfigurable processing elements such as CGRPs—or, more generally, reconfigurable processors (“RPs”)—particularly designed and/or configured to efficiently execute applications, Prabhakar, et al., “Plasticine: A Reconfigurable Architecture for Parallel Patterns,” ISCA '17, Jun. 24-28, 2017, Toronto, ON, Canada, (hereinafter, “Prabhakar”) describes example CGRPs and, systems utilizing such CGRPs, that can be particularly advantageous in dataflow system. U.S. Nonprovisional patent application Ser. No. 16/239,252, “VIRTUALIZATION OF A RECONFIGURABLE DATA PROCESSOR”, to Grohoski, et al, (hereinafter, “Grohoski”), and U.S. Nonprovisional patent application Ser. No. 16/922,975, “RUNTIME VIRTUALIZATION OF RECONFIGURABLE DATA FLOW RESOURCES”, to Kumar, et al, (hereinafter, “Kumar”), both incorporated herein by reference, further illustrate example implementations of CGRA-based computing systems utilizing CGRAs and CGRPs.

Kumar illustrates an example CGRS (in Kumar, “Reconfigurable Dataflow System”, or “RDS”) comprising user applications, programming libraries (e.g., deep learning frameworks), a software development kit, computation graphs associated with user applications, compilers, execution files that can specify operations of a user application to perform using reconfigurable processing resources of the CGRS and host and runtime processors. As illustrated in the examples of Kumar, user applications can comprise applications and a CGRS can comprise a plurality of physical racks each comprising one or more “nodes”.

In the examples of Grohoski and Kumar a node can comprise a host processor, a runtime processor, and CGRPs (in Grohoski and Kumar, variously “RDUs” or “RPs”). A host and/or runtime processor can, for example, facilitate compiling an application, determining particular CGR hardware resources to execute the application, and managing execution of the CGR hardware resources in performing operations of the application. A host and/or runtime processor can include kernel drivers and/or a user space library (e.g., a library of programs a user can include, or can invoke, in an application and that can execute in a user space of a runtime processor).

In various implementations, a CGRP can comprise reconfigurable processing elements with reconfigurable interconnections. Referring again to Grohoski and Kumar, CGRPs can comprise, for example, one or more arrays (“tiles”) of configurable processors (pattern compute units, “PCUs”) and/or memory units (pattern memory units, “PMUs”) that are reconfigurable to execute particular stages and/or computations of an application. Examples of Grohoski and Kumar illustrate a CGRS (RDS) and CGRPs (RDUs/RPs) comprising sub-arrays of PCUs/PMUs and multiples tiles interconnected by one or more networks (e.g., array level and top level networks in Grohoski and Kumar).

A CGRP can comprise I/O interfaces to enable CGRPs within a CGRS and/or among differing CGRPs, and/or elements of CGRPs, to communicate. For example, as illustrated by Kumar and Grohoski a CGRP can comprise hardware elements such as clock circuits, control circuits, switches and/or switching circuits, interconnection interface circuits (e.g., processor, memory, I/O bus, and/or network interface circuits, etc.). Kumar also illustrates that a CGRP can include virtualization logic and/or CGRP configuration logic. CGRPs such as described in Prabhakar, Grohoski, and Kumar can implement features and techniques of the disclosure and, accordingly, can serve to illustrate aspects of the disclosure. However, as previously cited, the disclosure is not necessarily limited to computing systems utilizing CGRPs.

Turning now to more particular aspects of the disclosure, applications can require massively parallel computations, involving massive quantities of data (e.g., tensor data), and where many parallel and interdependent computation threads (pipelines) exchange data. Such programs are ill-suited for execution on traditional, Von Neumann architecture computers. Rather, these applications can require architectures optimized for parallel and pipeline processing, such as CGRA based computing systems. The architecture, configurability and dataflow capabilities of a CGRS, and CGR components of a CGRS, such as CGRPs or elements of CGRPs, enable increased compute power that supports both parallel and pipelined computation.

However, applications such as ML and AI, and massively parallel architectures (such as CGRAs), place new and complex requirements to compile and/or execute the applications, or computations of the applications, on hardware of a dataflow system and, particularly, on CGRS hardware. Such requirements can include how computations of an application are pipelined among CGR hardware, which computations are assigned to which CGR hardware units (e.g., compute units and/or memories, how data is routed between various compute units and memories, and how synchronization among processors, memories, and data transfer hardware is controlled. These requirements can be particularly more complex in executing applications that include one or more nested loops, whose execution time can varies depending on the data being processed.

In implementations CGR components of a CGRS, for example, can be programmed to simultaneously execute multiple independent and interdependent operations. To enable simultaneous execution of application computations, such as computations within and across pipeline stages, a CGRS must distill applications from a high-level program to low level instructions to execute the program on CGR hardware resources. A high-level program is source code written in programming languages like Spatial, Python, C++, and C, and can use computation libraries for scientific and/or dataflow computing. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL. The low level instructions can comprise, for example, a configuration file describing a configuration of CGR components, as well as processor (e.g., CGRP) instructions and/or instructions for transferring application data among CGR components.

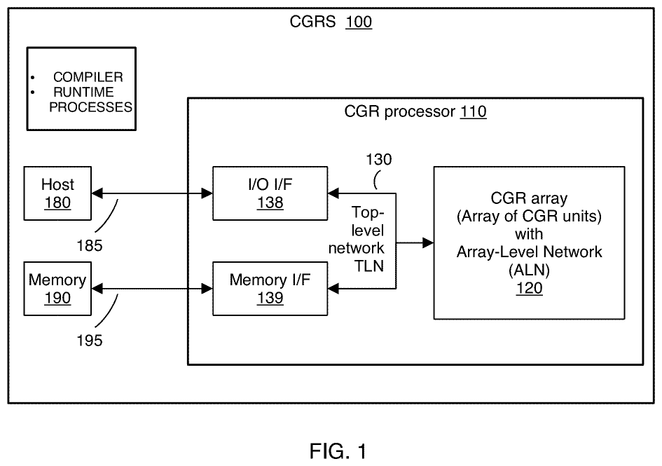

FIG. 1 illustrates an example reconfigurable dataflow system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via data bus 130 which can be part of a top-level network (TLN). Host 180 communicates with IO interface 138 via system data bus 185, and memory interface 139 communicates with memory 190 via memory bus 195.

An array of CGR units 120 can further include compute units and memory units that connected with an array-level network (ALN) to provide the circuitry for execution of a computation graph or a dataflow graph that can have been derived from a high-level program with user algorithms and functions. The high-level program can include a set of procedures, such as learning or inferencing in an AI or ML system. More specifically, the high-level program can include applications, graphs, application graphs, user applications, computation graphs, control flow graphs, dataflow graphs, models, deep learning applications, deep learning neural networks, programs, program images, jobs, tasks and/or any other procedures and functions that can need serial and/or parallel processing. In some implementations, execution of the graph(s) can involve using multiple units of CGR processor 110. In some implementations, CGR processor 110 can include one or more ICs. In other implementations, a single IC can span multiple CGR processors. In further implementations, CGR processor 110 can include one or more units of array of CGR units 120.

Host 180 can be, or can include, a computer such as will be further described with reference to the examples of Grohoski and Kumar. Host 180 can execute runtime processes, as further referenced herein, and can also be used to run computer programs, such as a CGRS compiler. In some implementations, the compiler can run on a computer that is similar to the computer described in the examples of Grohoski and Kumar, but separate from host 180.

CGR processor 110 can accomplish computational tasks by executing a configuration file (for example, a PEF file). For the purposes of this description, a configuration file corresponds to a dataflow graph, or a translation of a dataflow graph, and can further include initialization data. A compiler compiles the high-level program to provide the configuration file. In some implementations described herein, a CGR array is configured by programming one or more configuration stores with all or parts of the configuration file. A single configuration store can be at the level of the CGR processor or the CGR array, or a CGR unit can include an individual configuration store. The configuration file can include configuration data for the CGR array and CGR units in the CGR array, and link the computation graph to the CGR array. Execution of the configuration file by CGR processor 110 causes the CGR array (s) to implement the user algorithms and functions in the dataflow graph.

As used herein, the term “developer” of a dataflow system refers to application developers, who program dataflow applications. Ordinarily, a developer of a dataflow application is human developer; however, it will be appreciated by one of ordinary skill in the art that a developer of a dataflow system can be, alternatively, or can additionally include, an automated system or component of an automated system, such as a computing system, computing device, and/or computing program (e.g., a computing system utilizing artificial intelligence to develop an application, and/or using automated systems to execute a dataflow application).

As a CGRS can serve to represent a dataflow computing system, the ensuing examples of the disclosure refer to a CGRS as representative of a dataflow computing system. However, this is not intended to limit implementations and it will be understood by one of ordinary skill in the art that aspects of the disclosure illustrated using a CGRS can apply to implementations of dataflow systems, and/or components of or coupled to dataflow systems, other than a CGRS.

A developer and/or an application can utilize an application programming interface (API) of a CGRS to communicate with, and/or invoke, functions and/or services of a CGRS software components, such as a software development kit, runtime libraries, compilers and/or assemblers, assemblers, functions and/or services that can manage execution of a developer application on resources of a CGRS, and so forth. In implementations, an API can comprise a variety of software to software communications schemes, such as, for example but not limited to, programming function calls, data structures, function parameters and return arguments, a command line (CLI) interface, a message passing interface, and shared memory interfaces. A developer and/or application interface can comprise messaging protocols and/or communications interfaces, such as networks, I/O buses and/or links, and/or hardware elements of communications interface.

An application can comprise, and/or a CGRS can execute, an application in a pipeline, as a sequence of application stages. For example, in an AI or image processing application, applications can execute in an “extract, transform, and load (ETL)” pipeline. In this example, one stage of the application can perform application data extraction, which can comprise receiving (e.g., via a communications interface) and/or retrieving (e.g., from a memory or storage device or system) application input or partially processed (“results”) data. A successive (e.g., transformation) stage can perform data transformation of extracted data, such as “cleaning” (validating, and/or eliminating data among the extracted data), filtering (e.g., selecting a subset), and/or aggregation (e.g., computing averages, means, min/max, etc.) if extracted data.

Transformation can further include converting extracted data from one data type, format, or size to another, and/or to formatting extracted data in a particular data format or converting extracted data from one format to another. A further successive stage (e.g., a load stage) can, for example, output transformed data to processing and/or storage elements. This stage can output the transformation results to subsequent processing units and/or memory elements, or can store the results of the transformation for later processing.

In another example, a first application stage can comprise receiving and/or retrieving input application data (e.g., image data) and transforming the data to have a particular data type, format, and/or size (e.g., transforming input application data to a particular number of bytes of 32-bit integer data in row major format). A second application stage can process the data output from the first stage, such as to perform one or more computations of a neural network (e.g., a convolution operation) on a subset of application data. A third application stage can process results of the second stage, for example to analyze features of an image determined in the second stage.

A CGRS can comprise heterogeneous processing units to execute an application, and/or to execute particular operations or computations of an application or application stage. As used herein, “processing unit” refers to a CGR hardware element designed and/or configured to execute operations of an application. A processing unit can comprise, for example, a CGRP, one or more tiles, one or more PCUs/PMUs, a CPU, a GPU, and/or a specialized circuit, such as an FPGA. A CGRS can comprise a variety of such processing units and these processing units can have differing micro-architectures that, accordingly, can require, and/or can most efficiently process, application data of a particular type and format.

Similarly, applications, and various computational functions (e.g., tensor computation functions of an application), can comprise data of varying types and formats. Application data types can comprise, for example, integer data (e.g., 16-bit INT16 or 32-bit INT32) and differing precision floating point data (e.g., BF16, FP16, and FP32). Application data can have a particular format, such as row major (RM), column major (CM), row major vector align (RMVA), column major vector align (CMVA), and/or row vector align column major (RVCM) formats.

In dataflow systems, such as a CGRS, the design of a particular type of processing unit of a dataflow system (e.g., a CPU, GPU, and/or CGRP) can be such that the processing unit can process only stage data of one particular type and format. Similarly, a particular application operation (e.g., a particular computation, such as convolution) performed by a processing unit can be such that, in performing the operation, the processing unit can process stage data of only one particular type and format. On the other hand, the design of other types of processing units, and/or operations performed by a processing unit, can be such that the processing unit can process stage data of multiple, alternative types and/or formats.

Application data can be characterized by one or more “data attributes” corresponding to these varying data types and/or formats. As used herein, the term “stage data format”, or “SDF” for brevity, refers to a format of application data comprising data attributes processed in an application stage and/or processing units of a CGRS (or other dataflow system) pipeline. An SDF can comprise data attributes such as type and format of the particular application data. As previously described, data type can include data types, such as (but, not necessarily limited to) integer, floating point, data types) having a particular number of bits or bytes of a unit of the data; and, data format can include an organization of the data, such as (but, not necessarily limited to) row major, column major, row major vector aligned, column major vector align, and row vector align column major.

Components of a CGRS (e.g., a compiler and/or runtime processor) can allocate CGR hardware, such as particular processing units, and/or types of processing units, most suitable for executing, and/or pipelining, operations of an application or application stage to improve or optimize application execution performance. Selecting CGR hardware resources to execute an application can include selecting particular instances of CGR hardware resources, such as a particular set of processing units, to execute operations of each stage of an application pipeline in parallel. Operations” of an application, as used herein, encompasses processing application data (e.g., executing application computations), formatting application data, and transfer of application data and/or results among CGRS processing units to execute the application, or an application stage.

However, as previously described, a dataflow system, such as a CGRS, can comprise heterogeneous processing units, and certain processing units, or types of processing units, can execute particular application operations more efficiently (e.g., having higher execution throughput, lower execution latency, and/or higher hardware utilization) than other processing units, or other types of processing units. For example, a general purpose CPU can efficiently process flattened, scalar data, and/or general input/output operations to load data into, or receive data from, processing units and/or memories used to execute stage operations. A GPU or CGRP, in contrast, can generally perform vector and/or tensor computations, such as computational functions of a neural network, more efficiently than a CPU. At the same time, in comparison to a CPU, a GPU or CGRP (or, a particular type of GPU/CGRP) may not be as well suited to application data extraction and/or transformation. Thus, executing operations of an application or application stage can comprise a CGRS (e.g., a compiler or runtime processor of a CGRS) selecting particular types of processing units (e.g., a CPU, GPU, or CGRP) among CGR hardware to execute certain operations and/or application stages and selecting other types processing units to execute other operations and/or application stages.

Similarly, the microarchitectures of differing processing units can require data to have different types, sizes, or formats. For example, a CPU may support only single-precision and double-precision floating point data, while a GPU and/or CGRP can support half-precision, and/or “brain precision” data formats. A CPU may support data comprising double word (32 bit) sizes while a GPU or CGRP may support only word (16 bit) or half-word (8 bit) sizes.

Thus, based on their particular architectures, and/or to optimize their execution, particular processing units can require application data to have a particular SDF. As used herein, in the context of a processing unit, or other CGR hardware, “requiring” a particular SDF means that the processing unit or CGR hardware can require data to have, or be in, a particular SDF based on its microarchitecture and/or design, and/or that the processing unit or CGR hardware can more efficiently, or more optimally, process, input, output, and/or store the data having a particular SDF.

Data input to, and output from, an application stage, and/or CGRS hardware (e.g., memories and/or processors) is referred to herein as “stage data”. In implementations, stage data can include application input data (e.g., image data in an image processing application, such as a machine learning training application) and/or results of processing unit execution of application operations (e.g., results of processing application input data).

Stage data input to a pipeline stage, and stage data output from an application stage, can comprise data having the same SDF, for example, or results data output from a pipeline stage or processing unit can comprise a different SDF than an SDF of data input to that stage or processing unit. In pipelining application operations, data output from one application stage or processing unit may not necessarily be of an SDF required for processing in another application stage or by another processing unit in the pipeline (e.g., another processing unit executing a different type of application computation or operation). Executing a first stage (e.g., an N−1^{st} stage of an application pipeline) by one type of processing unit (e.g., a CPU) and a second stage (e.g., an N^{th} stage) by a different type of processing unit (e.g., a CGRP or array of PCUs/PMUs) can require converting stage data having one SDF, required by CGR hardware executing the first stage, to data having an alternative SDF required by CGR hardware executing the second stage.

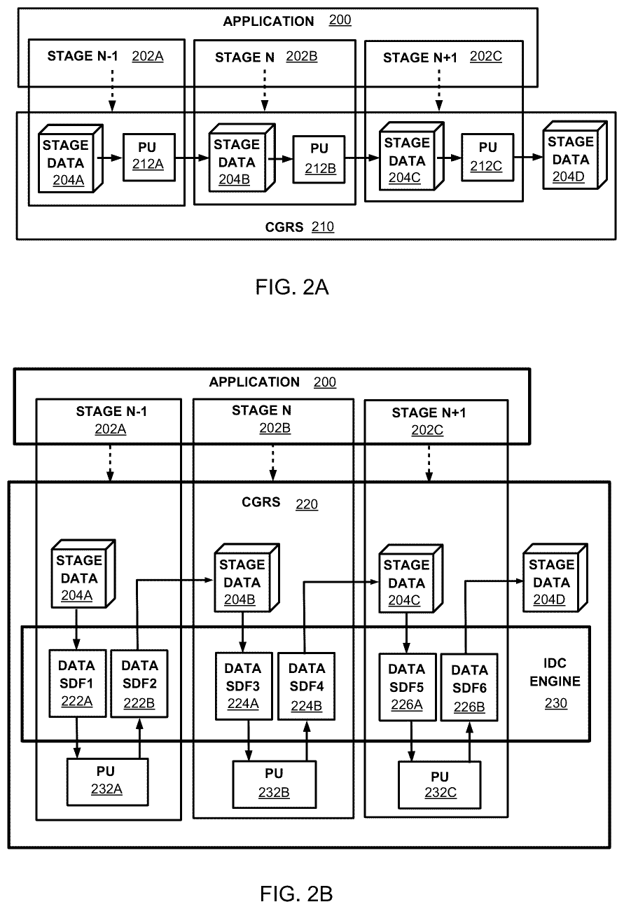

FIG. 2A illustrates an example application pipeline flow through an example dataflow system using the example of a CGRS. FIG. 2A depicts example application 200 executed by example system CGRS 210. CGRS 210 can comprise a CGRS such as illustrated in the examples of Grohoski and Kumar, for example, and is shown in FIG. 2A comprising processing units PU 212A, PU 212B, and PU 212C (collectively, “PUs 212”). Processing units among PUs 212 can comprise any type of processing unit as previously defined herein (e.g., CGRPs, CPUs, GPUs, etc.), and can be processing units suitable to execute operations, or particular operations, of application 200.

In FIG. 2A application 200 is shown comprising stage 202A, stage 202B, and stage 202C (collectively, “stages 202”) depicted, respectively, as stage N−1, stage N, and stage N+1 of the application. Each of stages 202 can be a stage of an application pipeline of application 200. For example, stage 202A can input application data (e.g., input application image data, and/or results of computations of other stages of application 200, such as a stage N−2 preceding stage 202A, not shown in FIG. 2A) for one or more processing units (and/or memories coupled to processing units) among PUs 212 to execute application operations of stage 202B and/or 202C. For example, stage 202A can include reading input stage data from a storage medium (e.g., a disk), and/or receiving data from another input source (e.g., a communications interface), to generate stage 202A input stage data, shown in FIG. 2A as stage data 204A.

Stage data input in stage 202A can comprise data in any particular data format (e.g., have particular data type and/or format attributes) corresponding an input source of the data, while particular PUs among PUs 212 utilized to execute operations of the application can process, or can process more efficiently, data of one or more particular SDFs. Thus, stage 202A can include converting stage 202A input stage data to generate stage data 204A having an SDF required, or best suited, based on their architecture or design, for the PUs to execute stage 202A operations.

Stage 202A can include loading stage data 204A, as received as input data and/or converted to a particular SDF, into CGR hardware (e.g., memories and/or PUs among PUs 212) to execute operations of the application using stage data 204A. A general purpose processing unit, a CPU among PUs 212, for example, can be well suited (or, can be best suited in comparison to alternative types of processing units) to inputting stage data, converting stage data between different SDFs to generate stage data 204A, and/or loading stage data 204A for processing by processing units among PUs 212.

Additionally, stage 202A can include executing, by PUs among PUs 212, computational operations of application 200 and stage data 204A can include results of the computations output by PUs among PUs 212 in executing computations of stage 202A. According to the type of stage 202A computations to execute, a CPU can be suitable for executing the computations. Alternatively, the stage 202A computations can be better suited for execution by a different type of processing unit, among PUs 212, and stage 202A can include transferring stage data 204A from a CPU to an alternative processing unit (e.g., a CGRP or GPU) to execute stage 202A computations. An alternative processing unit can process (or, can process only) data of an SDF different from that of the processing unit from which stage data 204A is transferred, such that the stage data 204A can (or, must) be converted to the different SDF for processing by that alternative processing unit.

Stage 202B can be a stage of application 200 that can comprise operations of application 200 using input stage data shown in FIG. 2A as stage data 204B. Stage data 204B can include data output from stage 202A. It can be the case that operations of a dataflow application can be executed best (e.g., most efficiently) by, for example, a more specialized processing unit of CGRS 210, such as a CGRP, GPU, or FPGA among PUs 212. Such processing units can require data having a particular SDF (e.g., 16-bit BF data in column vector align and row major, or “CVRM”, SDF) different from data included in stage data 204B, such that stage data 204B must be converted to that SDF (e.g., CVRM SDF) for processing by PUs executing stage 202B computations.

Similarly, stage 202C can be a stage of application 200 that can comprise operations of application 200 using input stage data shown in FIG. 2A as stage data 204C. Stage data 204C can include data output from stage 202B. It can be the case that operations of a dataflow application can be executed best (e.g., most efficiently) by a type or instance of a processing unit among PUs 212 different from those executing operations of stage 202B. The different processing unit can require data having a particular SDF (e.g., an 8 bit integer data in row major SDF) different from data included in stage data 204C, such that stage data 204C must be converted to that different SDF for processing by PUs executing stage 202C operations.

In implementations, stages among stages 202 can execute on processing units among PUs 212 in parallel. For example, as PU 212A completes processing of a portion of stage data 204A, in stage 202A, PU 212A can output results of processing that portion of stage data 204A, such as among stage data 204B, to PU 212B for PU 212B to process in parallel with PU 212A continuing to process additional data of stage data 204A (and/or PU 212A processing additional application data, and/or computational results of processing application data, of application 200). Likewise, as PU 212B completes processing of a portion of stage data 204B, in executing stage 202B, PU 212B can output results of processing that portion of stage data 204B, such as among stage data 204C, to PU 212C, for PU 212C to process in parallel with PU 212B continuing to process additional data of stage data 204B (and/or PU 212B processing additional application data, and/or computational results of processing application data, of application 200).

The example of FIG. 2A is intended only to illustrate the disclosure and not intended to limit implementations. While the example of FIG. 2A uses a CGRS as an example of a dataflow system, this example is not intended to limit implementations and one of ordinary skill in the art will appreciate that dataflow systems within the scope and spirit of the disclosure can comprise computing systems other than CGR systems, and/or that processing units of dataflow systems can comprise any type of hardware processor, combination of processors and/or memories, and/or specialized accelerators, specialized circuits, or combinations and/or configurations of these, in addition or alternative to processing units of a CGRS used to illustrate the example of FIG. 2A.

Additionally, one of ordinary skill in the art can appreciate that an application can comprise as few as two application stages, or can comprise many more stages than the 3 stages illustrated in FIG. 2A. Similarly, in implementations, a CGRS can comprise processing units of types in addition or alternative to those used in the example of FIG. 2A, that a CGRS can execute an application stage using many more processing units than one processing unit per stage, and that a combination of many heterogeneous processing units can execute a particular application stage. Thus, CGR hardware executing application stages, and/or operations thereof, can comprise heterogeneous processing and/or memory units that have differing microarchitectures, performance characteristics, latencies, and/or other architectural and/or design characteristics.

A compiler of, or for, a dataflow system, such as described in Kumar and Grohoski, can compile an application to execute particular application stages (whether or not the stages can form a pipeline) to execute on particular hardware processing resources based on those characteristics. Continuing the example of a CGRS as representing a dataflow system, the CGRS can comprise a compiler specific to its hardware architecture, such as the number and types of CGR hardware resources, their performance characteristics, and their interconnection topologies.

To further illustrate executing application stages by a CGRS, in a particular application one stage of the application can comprise, for example, data extraction of input application data. A CGRS compiler can determine that a CPU, for example, can efficiently perform the data extraction and can compile that stage of the application to execute on a CPU of a CGRS (and/or, a CPU coupled to the CGRS).

A second stage of the application can comprise data transformations, such as to filter the extracted data, and/or partition the application data (e.g., to tile an input image). A CGRS compiler can determine that a GPU or CGRP, for example, is best suited to execute these operations and can compile this successor stage of the application to execute on a GPU or CGRP of the CGRS (and/or, a GPU/CGRP coupled to the CGRS).

Yet another stage of the application can process application input data (which can include data among the transformed data), such as to perform operations of training a machine learning model of the application, or applying a trained application model of the application to extract image features, for example. A CGRS compiler can, similarly, determine that a GPU or CGRP, or a particular GPU or CGRP, for example, is best suited to execute these operations and can compile this stage of the application to execute on a GPU or CGRP, or particular GPU or CGRP, of the CGRS (and/or, a GPU/CGRP or particular GPU/CGRP coupled to the CGRS).

Similarly, stage data having a particular SDF can be better suited to storing the data in particular memory resources of a CGRS. Thus, a CGRS compiler can compile stages of an application to store input and/or output stage data having particular SDFs in particular memories utilized by processing units of a CGRS.

Stage data output from a processing unit executing a predecessor application stage of an application can be of an SDF different from that required by a processing unit executing a successor stage, or required by other CGR hardware, such as a register bank or memory. In such a case it can necessary, or advantageous, to convert the stage data from the SDF output from the predecessor stage to an SDF required by a processing unit executing operations of the successor stage. In one method of a dataflow system to convert stage data from one SDF to another between applications stages, stage data output from executing one application stage (a predecessor stage) can be stored for subsequent SDF conversion to execute a successor stage. To continue executing the application, the system can retrieve the stored output stage data, convert the data from the SDF output from the predecessor stage to an SDF required to execute the successor stage by particular CGR hardware, and then make the converted stage data available to the successor stage. Such a method can create data conversion boundaries between application stages—and associated execution latencies—that can inhibit, or degrade performance of, executing the application stages as a hardware pipeline among processing units of the system (e.g., processing units of a CGRS).

In another method, a processing unit executing operations of a predecessor stage (e.g., a stage N−1) of an application can convert output stage data, generated by processing units executing the predecessor stage and having a first SDF, to have a second SDF required by one or more processing units (e.g., of a different type than the predecessor processing units), or other CGR hardware, to execute a successor stage (e.g., a stage N) of the application. Similarly, a processing unit executing operations of the stage N of the application can convert output stage data having the second SDF, used by processing units executing that stage, to have a third SDF, required by one or more processing units (e.g., of a different type than stage N processing units)), or other CGR hardware, to execute a next successor stage (e.g., a stage N+1) of the application.

However, processing units executing various application stages can be sub-optimally suited, and/or underutilized, to perform such data conversions. Further, the need for such data conversions between stages can be opaque to a programmer of the application (e.g. the processing units can be abstracted such that SDF requirements are not evident at the application programming level), such that the conversions can introduce inefficiencies in program execution.

Intelligent Data Conversion

To improve execution of application stages, and/or pipelining of application stages, among processing units, and/or other dataflow system hardware, having differing stage data SDF requirements, implementations can utilize an “intelligent data conversion component, or “IDC engine”. An IDC engine can comprise software, firmware, and/or hardware components (e.g., processors and/or processing units, memories, and/or specialized electronic and/or logic circuits of dataflow system. An IDC engine can comprise, for example, one or more components of a CGRS and/or one or more components of a computing system communicatively coupled to a CGRS. In implementations, an IDC engine can comprise, for example, a program of a runtime component of a CGRS (e.g., a runtime processor, and/or a program of a runtime processor). An IDC engine can comprise a processor, and/or a computing system, included in or coupled to a CGRS.

An IDC engine can detect a “stage transition” associated with executing a dataflow application on a dataflow system. A stage transition can include, for example, transfer of data included among application stage data; input of stage data for processing by a processing unit; initiating execution of an application stage; initiating execution of the dataflow application, or an operation of the dataflow application (e.g., an operation included in an application stage) by one or more processing units; and/or, a change in an execution state of an application or application stage.

A transfer of stage data can comprise, for example, input of stage data from a memory, and/or a storage medium, to hardware (e.g., a processing unit or memory utilized by a processing unit) executing operations of an application stage. A transfer of stage data can comprise output of stage data from a predecessor processing unit, in an application pipeline, to a successor processing unit in the application pipeline, and/or output of stage data from a predecessor application stage to a successor application stage.

Initiating execution of an application stage can comprise a host system, and/or runtime processor, of a dataflow system (e.g., a CGRS) scheduling, and/or dispatching, processes, programs, and/or processing units to perform operations of that application stage. Initiating execution of a processing unit of the system to perform operations of an application, or application stage, can comprise a host system, and/or runtime processor, of a dataflow system (e.g., a CGRS) scheduling, and/or dispatching that processing unit to perform the operations.

A change in an execution state of an application or application stage can include, for example, a change in computations of the stage, a change in a state of a processing unit executing operations of that stage, or a transition of the dataflow system. and/or a processing unit from executing one application stage, or an operation of one application stage, to executing another application stage, or an operation of another application stage.

In response to, or in conjunction with, a stage transition an IDC engine can determine SDFs of stage data required by processing units and/or other system hardware to execute various application stages and can perform an SDF conversion of stage data from an SDF suited to one stage, and/or particular hardware element(s) executing operations of that stage, to an SDF more suitable for a successor stage and/or particular hardware element(s) executing operations of a successor stage. An IDC engine can interact with CGRS execution of application stages and can convert stage data as it is output by predecessor stage CGR hardware (e.g., a processor or memory) and/or input to successor stage CGR hardware, in parallel with execution stages of a hardware execution pipeline.

An IDC engine can determine that particular processing units can process only stage data of one particular SDF or, alternatively, can process stage data of multiple, alternative SDFs. In the latter case, an IDC engine can select an optimal SDF conversion from among the alternative conversions, and can determine and/or select particular processing units of a dataflow system to perform the conversion. For example, an IDC engine can determine that a CPU or a GPU (or a combination of these) is suitable, and/or preferable among processing units of a dataflow system, to perform an SDF conversion from FP32 to BF16. In contrast, an IDC engine can determine that CGRP (or other specialized processor and/or circuit) is suitable, and/or preferable among processing units of a dataflow system, to perform an SDF conversion from RM format to RMVA format.

An additional, or alternative, factor that an IDC engine can include to determine processing units to perform an SDF conversion is overhead and/or latency to transfer data input to, and/or output from, an SDF conversion. For example, a CGRP can perform a particular operation of an application stage and an IDC engine can determine that either the CGRP or a CPU can perform an SDF conversion of data output from the operation. It can be the case for a particular conversion (input SDF and output SDF) that a CPU can perform the conversion more quickly than the CGRP. However, to execute the conversion on the CPU can require transferring the input data from the CGRP to the CPU, which has a corresponding execution overhead (e.g., use of data transfer hardware, memories, and latency to perform the transfer). If the processing latency for the CGRP to perform the conversion is greater than the latency to transfer the data for conversion to the CPU, the IDC engine can determine to utilize the CPU to perform the conversion.

Alternatively, while a CGRP performing the conversion can require a longer processing latency, in comparison to a CPU, for example, the data to convert is in place on the CGRP (e.g., in a memory of the CGRP) as a result of the CGRP executing the operation. Thus, the processing latency for the CGRP to convert the data can be offset (e.g., be less than) the data transfer latency to transfer the data from the CGRP to the CPU to perform the conversion. In such a case, the IDC engine can determine to utilize the CGRP to perform the conversion.

An IDC engine can determine also that a conversion of stage data from one SDF to another SDF requires a sequence of intermediate SDF conversions. For example, converting stage data from FP32 RM SDF to a BF16 CVRM SDF can require first converting the data from FP32RM to BF16 RM, then converting the BF16 RM data to BF16 CVRM SDF. In another example, converting stage data from FP32 RM SDF to BF16 CMVA SDF can require first converting the data from FP32 RM to BF16 RM, then converting the BF16 RM data to BF16 CVRM SDF.

An IDC engine can determine what stage data requires conversion, when in executing the application stages to convert the data, and/or which CGR hardware components are best suited and/or available to convert the data. An IDC engine can itself perform an SDF conversion, in addition or alternative to dispatching CGR hardware processing units to convert stage data. An IDC engine can determine a particular SDF conversion, and/or order of multiple SDF conversions, from among the alternative SDFs and/or CGR hardware processing units to perform the conversions (including intermediate conversions) based on various SDF conversion optimization metrics. Implementations can include a “control plane” comprising control instructions, control decisions, and/or control data to control CGRS execution of an application (e.g., to control execution of CGRPs, transfer of application data among CGRPs and/or memories, and/or conversion of stage data) and an IDC engine can execute as a component of a control plane of a CGRS.

An IDC engine dispatching a processing unit to perform an SDF conversion encompasses the IDC engine scheduling and/or otherwise initiating (e.g., via an interface of the processing unit, or an interface of a software process and/or program executing on the processing unit) execution of the processing unit to perform the conversion. Scheduling the processing unit to perform the conversion can include, for example, communicating with a runtime processor of a CGRS to initiate execution of the processing unit to perform the conversion. Initiating the execution of the processing unit to perform the conversion can include, for example, a communication to the processing unit to perform the conversion. Initiating the execution of the processing unit to perform the conversion can include activating a software process and/or program to execute on the processing unit to perform the conversion, or a portion of the conversion. The IDC can itself initiate execution of the processing unit to perform the conversion, and/or can interact with another component of the dataflow system, such as a runtime processor, to initiate execution of the processing unit to perform the conversion.

SDF conversion optimization metrics can include, for example, execution time to perform a particular SDF conversion and/or a sequence of SDF conversions; suitability of a particular processing unit (e.g., a CPU, GPU, or CGRP) to perform a SDF conversion and/or a sequence of SDF conversions; availability of particular hardware elements (e.g., particular CPUs, GPUs, and/or CGRPs) during stage execution to perform a SDF conversion and/or a sequence of SDF conversions; and/or hardware resource utilization (e.g., processing unit, memory, and/or data transfer interface utilization) to perform a SDF conversion and/or sequence of SDF conversions. SDF conversion optimization metrics can include a number of data transfers of stage data among processing units and/or other hardware elements, and/or a latency of data transfers of stage data among processing units and/or other hardware elements, to perform an SDF conversion, and/or a sequence of intermediate conversions. SDF conversion optimization metrics can include, for example, processing unit execution latency, and/or throughput to perform an SDF or intermediate conversion.

FIG. 2B illustrates an example pipeline flow of example application 200, of FIG. 2A, through an example CGRS that includes an IDC engine. In FIG. 2B, CGRS 220 is shown comprising PUs 232A, 232B, AND 232C (collectively, “PUs 232”). PUs 232 can comprise processing units (an′/or other hardware elements of CGRS 220, such as memories and/or data transfer interfaces, such as I/O buses or links or communications interfaces) allocated, or that can be allocated, in CGRS 220 to execute application stages among stages 202 of application 200.

FIG. 2B further depicts CGRS 220 comprising IDC engine 230, which can interact with execution of stage among stages 202 by PUs 232 to convert stage data flowing in a pipeline among PUs 232—shown in FIG. 2B as stage data 204A, stage data 204B, and stage data 204C— from one SDF to another. IDC engine 230 can interact with execution of stage among stages 202 to perform the SDF conversions in parallel with PUs among PUs 232 executing operations of stage among stages 202. IDC engine can apply SDF conversion optimization criteria to intelligently select optimal SDF conversions (conversions of stage data to SDFs required or best suited for processing by particular processing units among PUs 232), and/or to determine an order of intermediate conversions (e.g., an order in which to dispatch processing units to perform a particular intermediate conversion) in a sequence of intermediate conversions.

As described with reference to FIG. 2A, stage data 204A can comprise data processed in and/or output from stage 202A, stage data 204B can comprise data processed in and/or output from stage 202B, and stage data 204C can comprise data processed in and/or output from stage 202C. In FIG. 2B, PU 232A can comprise one or more processing units, and/or other hardware of CGRS 220, to execute operations of stage 202A on stage data 204A; PU 232B can comprise one or more processing units, and/or other hardware of CGRS 220, to execute operations of stage 202B on stage data 204B; and, PU 232C can comprise one or more processing units, and/or other hardware of CGRS 220, to execute operations of stage 202C on stage data 204C.

In the example of FIG. 2B, IDC engine 230 can detect input of stage data 204A to PU 232A and/or execution of PU 232A to process stage data 204A. In response, IDC engine 230 can determine that PU 232A can process data among stage data 204A of a particular SDF, “SDF1”, and that data among stage data 204A is of an SDF different from SDF1, such that some or all of stage data 204A must be converted to have SDF1 for PU 232A to execute (or, efficiently execute) operations of stage 202A.

IDC engine 230 can determine and select a processing unit of CGRS 220 to convert data among stage data 204A to SDF1. IDC engine 230 can determine and select a processing unit of CGRS 220 based on the conversion to be performed and/or the order in which to perform the conversion among execution of operations of application 200 and/or stage 202A. IDC engine 230 can determine and select a processing unit among PUs 232, and/or an alternative processing unit of CGRS 220, not shown explicitly in FIG. 2B. IDC engine 230 can perform the conversion to SDF1 using the selected processing unit(s) and can output the converted data as DATA SDF1 222A for input to PU 232A to execute operations of stage 202A.

PU 232A can output data comprising results of operations of stage 202A, shown in FIG. 2B as DATA SDF2 222B and which can have a particular SDF, “SDF2”. PU 232A can output DATA SDF2 222B to include among stage data 204B for PU 232B to execute operations of stage 202B. IDC engine 230 can detect input of stage data 204B to PU 232B and/or execution of PU 232B to process stage data 204B. In response, IDC engine 230 can determine that PU 232B requires stage data 204B to have a particular SDF, “SDF3”, to execute operations of stage 202B, and that data included in stage data 204B comprises an SDF different from an SDF of data among stage data 204B.

IDC engine 230 can determine and select a processing unit of CGRS 220 to convert data among stage data 204B to SDF3. IDC engine 230 can determine and select a processing unit of CGRS 220 based on the conversion to be performed and/or the order in which to perform the conversion among execution of operations of application 200 and/or stage 202B. IDC engine 230 can determine and select a processing unit among PUs 232, and/or an alternative processing unit of CGRS 220, not shown explicitly in FIG. 2B.

IDC engine 230 can perform the conversion of data among stage data 204B to SDF3 using the selected processing unit(s) and can output the converted data as DATA SDF3 224A for input to PU 232B to execute operations of stage 202B. Similar to execution of stage 202A, PU 232B can execute operations of stage 202B using data among DATA SDF 224A, having SDF3, and can output data comprising results of operations of stage 202B, shown in FIG. 2B as DATA SDF2 224B, and which can have a particular SDF, “SDF4”. PU 232B can include DATA SDF4 224B among stage data 204C.

PU 232C can require that stage data 204C have a particular SDF, “SDF5”, to execute operations of stage 202C. As described with reference to stage 202A and 202B, IDC engine 230 can determine that PU 232C requires data having SDF5 and that data among stage data 204C is of an SDF other than SDF5. In response, IDC engine 230 can determine and select a processing unit of CGRS 220 to convert data among stage data 204C to SDF5. IDC engine 230 can determine and select a processing unit of CGRS 220 based on the conversion to be performed and/or the order in which to perform the conversion among execution of operations of application 200 and/or stage 202C. IDC engine 230 can determine and select a processing unit among PUs 232, and/or an alternative processing unit of CGRS 220, not shown explicitly in FIG. 2B.

IDC engine 230 can perform the conversion of data among stage data 204C to SDF5 using the selected processing unit(s) and can output the converted data as DATA SDF5 226A for input to PU 232C to execute operations of stage 202C. PU 232C can execute operations of stage 202C using data of stage data 204C, having SDF5, and can output data comprising results of those operations, shown in FIG. 2B as DATA SDF6 226B, among stage data 204D. DATA SDF6 224B can have a particular SDF, “SDF6”.

In implementations, an IDC engine can execute in parallel with, and/or interact with, processing units executing application pipeline stages. During application execution (“runtime”) an IDC engine can receive portions of the data output from one application stage, as a processing unit generates the output data, and can convert the output data to an alternative SDF suitable (or, optimal) for processing by a processing unit executing a successive stage of the application. The IDC engine can receive some or all of a predecessor stage output data (e.g., from a processing unit executing operations of the predecessor stage, and/or a memory storing results of the predecessor stage processing), convert the data to the alternative SDF, and input some or all of the converted data to a successor application stage (e.g., to a processing unit executing operations of the successor stage processing unit, and/or a memory storing converted successor stage output data). The IDC engine can detect the need to convert data among input and/or output stage data, determine and select processing units to perform the conversions, and execute the conversions in parallel with the predecessor and successor stage processing units executing operations of their respective application stages.

Thus, an IDC engine can execute as part of, or otherwise be included in, an execution pipeline executing stages of an application in parallel. Using the example of FIG. 2B, in parallel with processing units among PUs 232 executing operations of stage among stages 202, IDC engine 230 can convert data among stage data 204A to SDF1, convert data among stage data 204B from SDF2 to SDF3, convert data among stage data 204C from SDF4 to SDF5, and/or convert data among stage data 204D from SDF6 to an alternative SDF.

An IDC engine can, additionally or alternatively, interact with runtime management operations of a dataflow system, such as a runtime processor of a CGRS, to perform data conversions in an execution pipeline to execute an application. An IDC engine can interact with runtime management to, for example, determine SDFs required for particular processing units to execute an application stage. An IDC engine can interact with runtime management to coordinate execution of a particular application stage on particular processing units based on a required type of data conversion and/or order of a sequence of intermediate conversions. An IDC engine can convert application data, and/or interact with runtime management (e.g., a runtime processor) to select, schedule, and/or dispatch CGRS resources (e.g., CGRPs and/or other CGR hardware), based on particular application execution metrics. The application execution metrics can include, for example, processing unit utilization, processing unit execution and/or memory throughput, processing unit execution latencies; data transfer latencies; and/or particular SDF conversion optimization metrics, such as previously described.

FIG. 3A illustrates in more detail an example CGRS comprising an IDC engine. In FIG. 3A CGRS 300 is shown comprising a host computing system, host 302, and processing units PU 308A, PU 308B, and PU 308C (collectively, “PUs 308”). In an implementation, host 302 can be a host computing system such as illustrated by the examples of Kumar and Grohoski, or example host 180 of FIG. 1. Processing units among PUs 308 can be processing units of a CGRS such as previously described (e.g., CGRPs, CPUs, GPUs, and/or other processors, of a CGRS).

Host 302 is shown, in FIG. 3A, comprising processor 314, memory 306, and RTP 304. Processor 314 can comprise one or more general purpose processors, such as one or more CPUs, and/or other processor types, such as special purpose processors/circuits or CGRS processing units. Processor 314 can execute programs of host 302, such as operating system programs, CGRS compiler programs, and/or programs to execute a dataflow application such as in the example of application 200 in FIGS. 2A and 2B.

Memory 306 can store instructions and/or data of programs executed by processor 314. Memory 306 can additionally, or alternatively, store data to convert from one SDF to another, and/or {DF conversion results (data converted from one SDF to another). Memory 306 can store instructions for IDC engine 310 to process stage data of differing application stages and/or processed by differing processing units among PUs 308.

RTP 304 can be a runtime processor such as illustrated by the examples of Kumar and Grohoski. RTP 304 can include a processor (not shown in FIG. 3A), such as a processor similar to processor 314 of host 302. RTP 304 can include programs executable on such a processor, and/or processor 314, and the programs can initiate and/or control execution of an application by PUs among PUs 308. Memory 312 can store programs and/or data of RTP 304.

FIG. 3A further illustrates example IDC engine 310 included in RTP 304. IDC engine 310 can comprise a component of RTP 304, such as a program and/or processor of RTP 304, specialized circuits of RTP 304, and/or a combination of these. IDC engine 310 can be wholly included in RTP 304 or, alternatively, a subset of components of IDC engine 310 can be included in RTP 304. RTP 304 can monitor status of application stage execution by PUs among PUs 308, and/or transfer of stage data among PUs 308 executing stages of an application, and can communicate to IDC engine 310 status of application stage execution by PUs among PUs 308, and/or transfer of stage data among PUs 308. IDC engine 310 can communicate to RTP 304 status of conversions of data among stage data from one SDF to another.

IDC engine 310 can detect execution of application stages and/or transfer of stage data among PUs 308, convert application data from one SDF to another, and/or to receive and/or communicate status of stage data SDF conversions to host 302 and/or RTP 304. FIG. 3A further illustrates IDC engine 310 comprising memory 312 (alternatively, IDC engine 310 can be coupled to memory 312 and/or memory 306). IDC engine 310 can utilize memory 312 and/or memory 306, for example, to store and/or retrieve stage data for conversion from one SDF to another. IDC engine 310 can utilize memory 312 and/or memory 306 to store stage data converted from one SDF to an alternative SDF.

IDC engine 310 can execute program instructions, using host 302 and/or a processor of RTP 304. IDC engine 310 can include a processor (not shown in FIG. 3A) and can execute programs of IDC engine 310 on the processor. Programs of IDC engine 310 can enable, or facilitate, IDC engine 310 to detect execution of application stages and/or transfer of stage data among PUs 308, convert stage data from one SDF to another during execution of application stages and/or CGR hardware (e.g., processing unit) execution pipelines, and/or to receive and/or communicate status of stage data SDF conversions to host 302 and/or RTP 304.

IDC engine 310 can include specialized processors and/or circuits (also not shown in FIG. 3A) and the specialized processors/circuits can enable, or facilitate, IDC engine 310 to detect execution of application stages and/or transfer of data among PUs 308, convert stage data from one SDF to another during execution of application stages and/or CGR hardware (e.g., processing unit) execution pipelines, and/or to receive and/or communicate status of stage data SDF conversions to host 302 and/or RTP 304.

While the example of FIG. 3A illustrates IDC engine 310 as a component of host 302, and RTP 304 as a component of host 302, this is only to illustrate the disclosure and not intended to limit implementations. For example, IDC engine 310 can, alternatively, be a component of host 302, and RTP 304 can be a runtime processor coupled to, rather than included in, host 302. It would be apparent to one of ordinary skill in the art that a host computing system, runtime processor and IDC engine can be configured in many varieties of configurations other than as illustrated in FIG. 3A.

In FIG. 3A, PUs 308 are shown coupled to IDC engine 310 by interface 316A, interface 316B, and interface 316C (collectively, “interfaces 316”). Interfaces among interfaces 316 can comprise, for example, data and/or memory buses, I/O links (e.g., PCI or InfiniBand links) communications interfaces, network interfaces, or any particular interface, or combination of interfaces, suitable for IDC engine 310 and PUs 308 to communicate to IDC engine 310, and/or RTP 304, application stage execution status, transfer of stage data among PUs 308, and/or conversion of stage data from one SDF to another.

FIG. 3B illustrates in an alternative example CGRS comprising an IDC engine. In FIG. 3B, CGRS is shown comprising host 322, RTP 328, IDC engine 330, and processing units PU 340A, PU 340B, and PU 340C (collectively, “PUs 340”). In implementations, host 322 can be a host computing system similar to host 302 of FIG. 3A and is shown including processor 324 (which can be a processor similar to processor 314 in FIG. 2A) and memory 326 (which can be a memory similar to memory 306 in FIG. 3A).

RTP 328 can be similar to RTP 304 of FIG. 3A. However, CGRS 320 illustrates that a CGRS can include a runtime processor (RTP 304) in addition to, and not necessarily included in, a host computing system (while not shown in FIG. 3B, host 322 can include a runtime processor in addition to runtime processor 324). CGRS 320 further illustrates that a CGRS can include an IDC engine that is not included in a host or runtime processor but, rather, communicatively coupled to a host or runtime processor. As shown in FIG. 3B, IDC engine 330 is commutatively coupled, via interface 338A and interface 338B, respectively, to host 322 and RTP 328. Interface 338A and/or interface 338B can comprise, for example, data and/or memory buses, I/O links (e.g., PCI or InfiniBand links) communications interfaces, network interfaces, or any particular interface, or combination of interfaces, suitable for IDC engine 330 and PUs 340 to communicate with host 302 and/or RTP 328. Interface 338A and/or interface 338B can include an application programming interface of programs of host 322, RTP 328, and/or IDC engine 330.

Via interface 338A and/or interface 338B, for example, IDC engine 330 can receive communications from host 322 and/or RTP 328, respectively, to detect execution of application stages and/or transfer of stage data between application stages, to determine and convert stage data from one SDF to another during execution of application stages and/or an application execution pipeline, and/or to communicate status of stage data SDF conversions to host 322 and/or RTP 328.

While not shown in FIG. 3B, host 322 can internally (e.g., via memory buses, internal I/O buses or links, and/or memory or data buses) couple components of host 322 (e.g., memory 326 and/or processor 324) to interface 338A to facilitate communications and/or interactions between IDC engine 330 and host 322. Similarly, and while also not shown in FIG. 3B, RTP 328 can internally (e.g., via a memory, internal I/O buses or links, and/or memory or data buses) couple components of RTP 328 e.g., a memory and/or processor of RTP 328) to interface 338B to facilitate communications and/or interactions between IDC engine 330 and RTP 328.

In the example of FIG. 3B, PUs 340 are coupled to IDC engine 330 by interfaces 336A, 336B, and 336C (collectively, “interfaces 336”). Interfaces among interfaces 336 can comprise, for example, interfaces similar or equivalent to interfaces 316, and can include an application programming interface of programs of host 322, RTP 328, and/or IDC engine 330. Interfaces among interfaces 336 can comprise, for example, data and/or memory buses, I/O links (e.g., PCI or InfiniBand links) communications interfaces, network interfaces, or any particular interface, or combination of interfaces, suitable for IDC engine 330 and PUs 340 to communicate status of application stage execution and/or stage data transfer, and/or for IDC engine 330 to receive stage data from, and/or output converted stage data to PUs among PUs 340.

Host 322 can utilize memory 326, for example, to store stage data to convert from one SDF to another), and/or to store data converted from one SDF to another. Host 322 and/or IDC engine 330 can utilize memory 326 to store instructions for IDC engine 330 to process stage data. RTP 328 can have access to memory 326 (and/or include a memory, not shown in FIG. 3B) and RTP 328 and/or IDC engine 330 can utilize memory 326 (and/or a memory included in RTP 328) to convert from one SDF to another), to store data converted from one SDF to another, and/or to store instructions for IDC engine 330 to process stage data.

FIG. 3B illustrates IDC engine 330 comprising memory 332 and processor 334. Alternatively, memory 332 can be a memory coupled to IDC engine 330. IDC engine 330 can utilize memory 332 to, for example, retrieve stage data input to, and/or output stage data from, a processing unit executing a stage of an application, for conversion from one SDF to an alternative SDF, and/or to store data converted from one SDF to an alternative SDF.

Processor 334 can be a processor suitable for executing programs of IDC engine 330, such as programs to detect execution of an application stage and/or transfer of data among processing units and/or other CGRS hardware executing an application stage; determine processing units and/or other CGRS hardware available and/or required to execute an application stage; determine SDFs of stage data required by processing units and/or other CGRS hardware to execute an application stage; and/or initiate, perform, and detect completion of SDF conversions of stage data. Processor 334 can include, or be coupled to, specialized electronic or logic circuits for IDC engine 330 to detect stage execution and/or stage data transfers, and/or to perform SDF conversion of stage input/output data. Processor 334 can utilize memory 332 (and/or a memory coupled to IDC engine 330 and accessible to processor 334) to perform operations of IDC engine 330.

While FIGS. 3A and 3B illustrate examples of IDC engines included in a runtime processor of a computing system, and of a CGRS, respectively, this is only to illustrate the disclosure and is not intended to limit implementations. It will be appreciated by one of ordinary skill in the art that an IDC engine can be a component of any element of a dataflow system, or a computing system or processor coupled to a dataflow system capable of interacting with execution of an application by a dataflow system (e.g., interacting with components of a dataflow system that control, manage, or perform operations of application execution).

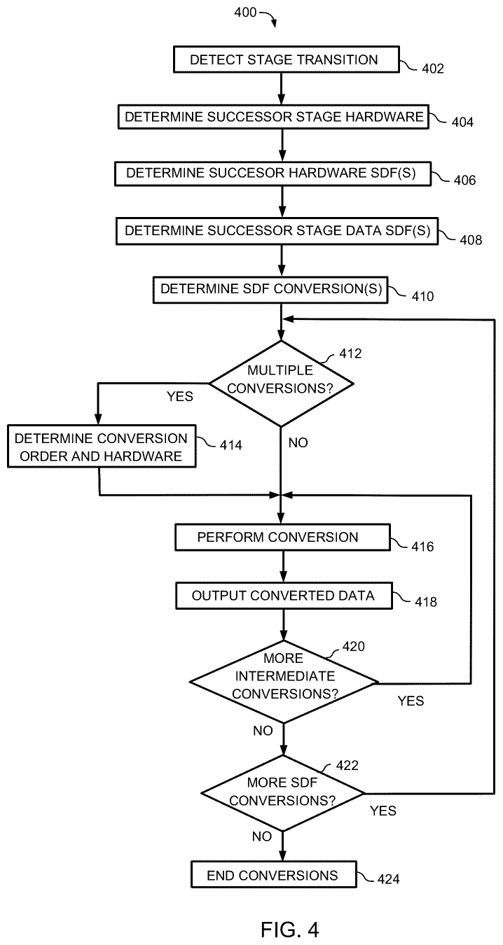

FIG. 4 illustrates an example method for performing intelligent SDF conversion of stage data between application stages and/or processing units executing application stages. FIG. 4 illustrates method 400 for performing operations of an IDC engine, such as previously described. For purposes of illustrating the method, but not intended to limit implementations, the method is described as performed by an IDC engine (“the IDC engine” in referent to operations of method 400) included in a CGRS (as an example of a dataflow system). The IDC engine can be an IDC engine such as illustrated in the examples of FIGS. 3A and 3B (e.g., an IDC engine similar or equivalent to IDC engine 310, of FIG. 3A, or IDC engine 330 of FIG. 3B).

For further purposes of illustrating the method, the IDC engine can be considered a component of a CGRS having a plurality of processing units, which the processing can be heterogeneous, and/or can include CPUs, GPUs, FPGAs, CGRPs, and′/or other processor types suitable for performing operations of a dataflow system (e.g., operations of a compiler, host computing system, runtime processor, executing operations/computations of a dataflow application, etc.). The processing units can include processing units capable of performing operations of an IDC engine such as described in reference to the examples of FIGS. 2B, 3A, and 3B. In references to operations of method 400, the term “PUs” and “the PUs” refers inclusively to processing units and/or other CGR hardware (e.g., memories and/or data transfer hardware) of the CGRS executing the application.

Turning to details of method 400, in operation 402 of method 400, during execution of the application by the CGRS, the IDC engine detects a stage transition associated with the CGRS (e.g., PUs and/or a runtime processor of the CGRS) scheduling and/or executing one or more stages of the application. In implementations, in operation 402 the IDC engine can interact with a host system, runtime processor, and/or the PUs to detect the stage transition. For example, a host system and/or runtime processor can dispatch PUs to execute an application stage and can communicate to the IDC engine that stage execution has been scheduled, initiated, or is in progress. The communication can include identifying particular PUs allocated and/or dispatched to execute the application stage. In another example, the IDC engine and the PUs (or, a subset of the PUs) can have an interface such as among interfaces 316 of FIG. 3A or interfaces 336 of FIG. 3B, for the IDC engine to communicate with, and/or receive a signal or communication, from the PUs (PUs outputting stage data and/or PUs receiving output stage data) to detect execution of an application stage and/or transfer of stage data between PUs.

In operation 404, in response to detecting the stage transition in operation 402, the IDC engine determines CGR hardware (e.g., “successor PUs”) to receive and process input stage data for a successor stage of the application (“successor stage data”). The successor stage data can include stage data output from one or more predecessor PUs among the PUs, and/or application input data associated with the successor stage (e.g., input image data in an image processing application, and/or backpropagation data in a neural network).

In operation 404 the IDC engine can determine the successor PUs based on interactions and/or communications with a host system, runtime processor, and/or the PUs (e.g., predecessor and/or successor PUs). Alternatively, or additionally, the IDC engine can determine successor stage hardware based on outputs of a CGRS compiler having compiled the application for execution on CGRS hardware, such as and/or an execution file as described in Kumar.

In operation 406, the IDC engine determines one or more successor stage SDFs of stage data that the successor PU(s) can process in executing operations of the successor stage. The IDC engine can determine a particular successor stage SDF, from among possible alternative successor stage SDFs a successor PU can process, that can enable a successor PU to most efficiently process stage data. For example, in operation 406 the ISC can determine that a successor PU can process stage data in RM and RMVA SDFs.

However, it can be the case that processing stage data in the RM SDF requires use of an additional CGRS (or, PU) hardware component to align the RM SDF data (i.e., to make it vector aligned). Thus, processing the successor stage data in RM mode can lower utilization (and/or increase execution latency) of the processing unit operating on that data, in comparison to utilization (and/or execution latency) of that processing unit to process the data in the RMVA SDF. Thus, in this example, the IDC engine can determine in operation 406 to convert successor stage data in the RM SDF, or another SDF, to be in the RMVA SDF, based on successor PU utilization, and/or execution latency, as a conversion optimization metric.

In operation 406, the IDC engine can determine the successor stage SDFs based, for example, on the type (e.g., microarchitecture and/or other design characteristic) of a successor PU. Additionally, or alternatively, the IDC engine can determine the successor stage SDFs based on conversion optimization metrics, such as previously described. The IDC engine can determine then successor stage SDFs based on whether the PUs among the predecessor and/or successor PUs can efficiently perform an SDF conversion, versus whether the IDC engine (e.g., processors and/or other hardware of an IDC engine) can more efficiently perform the conversion.

In operation 408, the IDC engine determines SDF(s) of data included in the successor stage data and, in operation 410, determines one or more particular SDF conversions to convert successor stage data from an SDF determined in operation 408 to a successor stage SDF determined in operation 406. In operation 410, the IDC engine can determine that the successor stage data has one SDF and, in operation 406 that the successor PUs process data of only one, alternative SDF, such that only one SDF conversion is required.

Alternatively, in operation 410 the IDC engine can determine that the successor stage data has one SDF and, in operation 406 that the successor PUs can process data of multiple, alternative SDF, such that the IDC engine can determine multiple, alternative SDF conversions. In another alternative, in operation 410 the IDC engine can determine that the successor stage data comprises multiple SDFs and, such that the IDC engine must convert successor stage data of each of the multiple SDFs to one or more of the SDFs determined in operation 406.

In operation 412, the IDC engine determines if one or more of the SDF conversions determined in operation 410 requires a sequence of intermediate conversions, such as illustrated by the previous examples of converting stage data from FP32 RM to BF16 CVRM (requiring two intermediate conversions), and converting stage data from FP32 RM to BF16 CMVA (requiring three intermediate conversions).

If the IDC engine determines, in operation 412, that there are intermediate conversions required to convert successor stage data to a successor stage SDF, in operation 414 the IDC engine determines particular intermediate conversions, and processing units of the CGRS (or, coupled to the CGRS), to perform each of the intermediate conversions. In operation 414 the IDC engine can determine a particular intermediate conversion based on, for example that particular conversion improving an SDF conversion optimization metric in comparison to other, alternative, intermediate conversions.

In the case that the IDC engine determines, in operation 412, that the successor stage data requires multiple intermediate conversions, in operation 414 the IDC engine can determine particular processing units (and/or other hardware of the CGRS, and/or hardware coupled to the CGRS) to perform the intermediate conversions. Additionally, in operation 414 the IDC engine determines a conversion order (e.g., a preferred or optimal order) to perform the conversions. The conversion order can comprise an order in which to perform each intermediate conversion, and/or dispatch each processing unit to perform a respective intermediate conversion. The IDC engine can determine the conversion order based, for example, on availability of a processing unit to perform a particular conversion, and/or processing and/or data transfer efficiency or overhead to perform a particular intermediate conversion or to perform the collective conversions according to a particular order.

In operation 414, to determine processing elements to perform the conversions, and/or an order in which to perform the conversions, the IDC engine can apply a conversion cost model. The conversion cost model can compute SDF conversion costs (e.g., conversion latencies) to determine processing elements and/or an order and/or combination of SDF conversions that can optimize the conversions (e.g., minimize conversion latency, and/or increase utilization of processing elements, etc.).

In implementations, a conversion cost model can comprise an equation incorporating a set of PDG conversions and their respective processing times, times to transfer converted data among processing elements, to perform the conversions using particular processing elements in a particular order. In operation 414, the IDC engine can execute the cost conversion model with varying alternative processing elements, and/or orders of processing elements, to perform the multiple conversions determined in operation 412.

As an example, in one such equation, c is a number of conversions, O(i) is the ith conversion under order O, t is the time of conversion h(i) i executing on processing element h, t is the time to transfer output data of conversion h→(i) ith from processing element h to the processing element executing the next conversion (for example, a PU of the CGRS executing a successor application stage, or a successor operation of an application stage within an application execution pipeline comprising multiple PUs). By applying the conversion cost model to varying alternative processing elements and/or orders of processing elements, the IDC engine can determine one or more combinations of processing elements and SDF conversion orders, (h, o), that can minimize the conversion cost, computed as Σ(th(i)+th→(i))) over i=O(1) to O(c).

In operation 416 the IDC engine initiates an SDF conversion determined in operation 410, or a next intermediate conversion, according to the conversion order, among intermediate conversions determined in operation 414. In the case that the IDC determined, in operation 410, that there are multiple successor stage data SDFs to convert to a successor stage SDF, in operation 416 the IDC engine can select data of one of the successor stage data SDFs to convert to a successor stage SDF.

In the case that the IDC determined, in operation 410, that there are multiple, alternative SDFs available to convert the successor stage data, in operation 416 the IDC engine can select a preferred conversion from among the alternative SDFs to convert in operation 416. The IDC engine can select the preferred conversion based, for example, on comparing conversion optimization metrics associated with each of the alternative SDFs, and/or conversion optimization metrics associated with processing units to perform each of the alternative SDF conversions. The IDC engine can select a preferred conversion by applying a conversion cost model, such as described in reference to operation 414.

In operation 416, the IDC engine can itself perform the conversion or, alternatively, can determine that CGRS hardware (e.g., particular processing units of a CGRS) can perform the conversion. The IDC engine can perform the conversion as an element, or stage, of a pipeline of PUs executing application stages. In operation 416, the IDC engine “initiating” the conversion can comprise dispatching, or scheduling dispatch of, a program, process, and/or processing unit of the IDC engine and/or CGRS to perform the conversion.

The IDC engine can initiate the conversion, and/or output converted stage data, in response to, or in conjunction with a stage transition of the predecessor and/or successor stages and/or PUs executing the predecessor and/or successor stages. For example, in operation 416 the IDC engine can delay performing the conversion lending a stage transition in which execution of the predecessor stage and/or PUs have reached a state in which stage output data is ready to convert, and/or execution of the successor stage and/or PUs have reached a state in which successor stage data can be input and/or processed.

In operation 418, the IDC engine outputs, and/or initiates or schedules output, of the converted successor stage data. The IDC can, in operation 418, output the converted successor stage data to the successor PUs and/or memories of or accessible by successor PU, executing one or more stages of the application; to a storage medium, such as a disk storage medium; and/or to a communications interconnection or interface, such as a network or network interface among components of the CGRS. The IDC can, in operation 418, output the converted successor stage data to a component of a host computing system, runtime processor, the IDC engine, and/or a component of the CGRS.

In operation 420, the IDC engine determines if there are additional intermediate conversions, among the intermediate conversions determined in operation 414, to perform to complete an SDF conversion determined in operation 410. If so, in operation 420 the IDC engine selects a next intermediate conversion (according to the conversion order) and repeats operations 416-420. In repeating operations 416-420 the IDC engine can synchronize executing the intermediate conversion, in operation 416, by the processing element determined in operation 414, with the state of execution of the application stage(s). For example, in operation 416 the IDC engine can delay executing the intermediate conversion selected in operation 420 until the processing element to perform the conversion is available to do so. The IDC engine can interact with the PUs and/or other components of the CGRS (e.g., a host system and/or runtime processor) to determine when to execute operations 416 and 418 with a next intermediate conversion in the conversion order.

If the IDC engine determines, in operation 420, that there are no additional intermediate conversions to perform (e.g., all intermediate conversions determined in operation 414 are complete), in operation 422 the IDC engine determines if there are additional SDF conversions, among conversions determined in operation 410, to perform. If so, the IDC engine repeats operations 412-422. Alternatively, if the IDC engine determines in operation 422 that there are additional SDF conversions to perform, in operation 424 the IDC engine ends determining and performing conversions associated with the stage transition detected in operation 402.

Intelligent Data Transfer

Application developers (e.g., programmers writing a dataflow application) can have a description of CGR hardware—processing units and/or memories, for example—used by the system to execute the application. A programming language (e.g., Python), and/or a software development kit (SDK) of a CGRS (e.g., an SDK as illustrate in the examples of Kumar) can include syntactical constructs describing CGR hardware, including processing units and memories of a CGRS.

Commonly, in executing a dataflow application, application input data and/or computational output data, must be transferred among differing memories of a dataflow system for processing by differing processing units. CGR hardware can include a variety of memories and the memories can be of heterogeneous types, performance characteristics, hardware interconnection mechanisms, and/or location within hardware topology of a computing system. For example, as illustrated by the examples of Grohoski and Kumar, memories of a dataflow computing system, and particularly memories of a CGRS, can comprise memories of a host computing system (hereinafter, referred to as “CPU memories”); CGRP memories, such as SRAM, DRAM, and/or PMU memories of, or coupled to, a CGRP; high performance memories (“HPMs”), which can be included in or coupled to CGRPs and/or other components of a CGRS, such as a host computer; storage media, such as magnetic or optical media of hard drive or CD/DVD ROMs, and/or non-volatile memory storage devices; and/or network attached memories (NAM) and/or storage devices (NAS).

Processing units and memories can store stage data (application input data and/or computational results output data) in executing an applications on a CGRS involves computational units and memories in which, are stored. Selection (e.g., in programming an application) of particular CGRS processing (computational) and memory resources to execute an application can significantly affect application execution. In particular, execution of an application can involve moving stage data among memories most suited for storing and/or processing particular stage data. For example, a large volume of application data can be stored (owing to its volume) on a storage medium, such as a disk system or large non-volatile memory. However, processing the application data by a CGRP of a CGRS can require access, by the CGRP, to portions of the data in a memory of the CGRP itself, or closely coupled to the CGRP to achieve processing performance objectives.

Similarly, a CGRP can store results of computations involving application data in a memory optimal for access by that CGRP. However, in parallelizing (pipelining and/or concurrently executing) computations among CGRS (e.g., among nodes of a CGRS) and/or CGRP resources (e.g., tiles and/or PCUs of tiles), other CGR hardware (e.g., another CGRP) may require transfer of stage data from a source memory to an alternative, destination memory that can be better (or, best) suited for processing by those other resources. Thus, CGRS execution of an application commonly requires the CGRS to move data, at runtime, among various components of the CGRS. U.S. Provisional patent application No. 63/321,654, titled “DIRECT ACCESS TO RECONFIGURABLE PROCESSOR MEMORY”, to Turlik, et al (hereinafter, “Turlik”) describes methods of transferring data among source and destination memories of a CGRS, for example.

A CGRS can provide a variety of transport methods, and CGR hardware to execute the methods, to transfer data among CBR hardware components. For example, direct memory access (DMA) and memory-mapped data copy can be used between host and a local CGRP, remote direct memory access (RDMA) can be used between host and a remote CGRP, and local fabric, RDMA can be used between two CGRPs, etc. Each transport method comprises CGR hardware and/or software initialization and control particular to that method. This can require that a developer and/or application account for such details (e.g., to select particular methods and/or CGR hardware) in programming transfer of stage data among CGR hardware components.

A developer can, in an application, specify particular CGR hardware, such as particular processing units and/or memories, to execute the application, so as to achieve particular application execution objectives. Such objectives can include, for example, achieving a particular application time of execution, and/or prioritizing execution of certain computations, and/or processing of certain application data, over others. Such objectives can include selecting particular resources for executing the application, such as resources that may have different execution monetary costs, resources that have particular characteristics (e.g., larger memories that may hold more data than smaller memories), or resources particularly suited to particular computations or data among the application data.

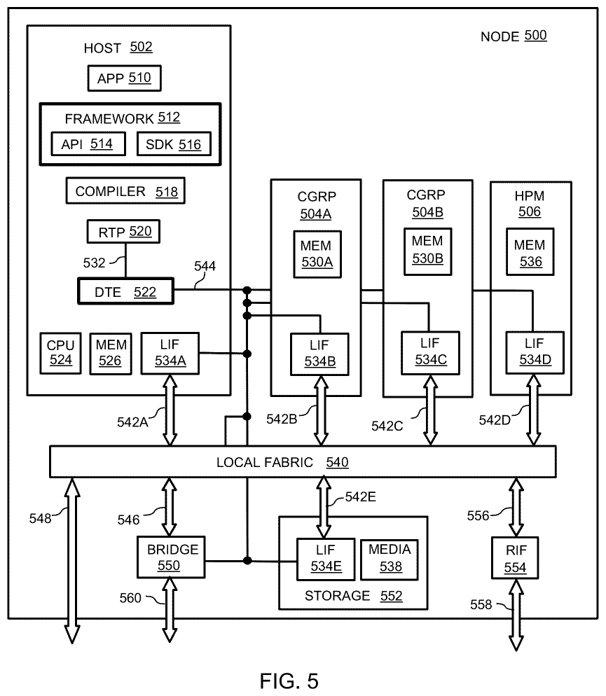

A developer can include such specifications among programming statements and/or compiler or runtime directives of an application and a compiler, such as illustrated in the example of FIG. 5, or SDK can generate low level instructions and/or configuration information (e.g., a PEF in the examples of Kumar) for the CGRS to utilize the resources specified in the application. A runtime processor of a CGRS can use the compiler output and/or configuration specification to schedule and/or dispatch CGR hardware (e.g., CGRPs or other processing units) to execute the application.

However, this can pose problems, or limitations, in developing and/or executing the application. The manner in which a programming language and/or SDK represents CGR hardware to a developer can make developing the application more complex, such as in a system in which CGR hardware is described very specific to the design of the CGR hardware to indicate particular memory types/characteristics, hardware topologies, and/or methods to transfer data among CGR hardware memory and/or processor resources. To achieve certain application executions objective, the application developer can be consequently required to program the application to closely select and manage use of particular resources, such as memories, and execution of the application, such as moving application data among the memories.

A more abstract representation of CGR hardware can facilitate more efficient and simpler application development. However, an abstract representation of CGR hardware can specify performance characteristics of particular resources but, in order to achieve a preferred level of abstraction, may do so at only very high levels. Performance characteristics of particular CGR hardware, and or topological location and/or interconnections of CGR hardware, can affect execution of the application using those resources. Use of particular CGR hardware, and or topological location and/or interconnections of CGR hardware can affect, for example, overall execution time, utilization of processing units and memories associated with transferring data among the processing units and/or memories, and/or utilization of CGR interconnect hardware associated with transferring data among the processing units and/or memories; and/or latencies associated with transferring data among the processing units and/or memories. Abstract representations of CGR hardware can obscure such factors and can limit the ability of the developer to optimize CGRS execution of the application.

An additional problem with application selection of CGR hardware can arise during execution of the application by the CGRS, as CGR hardware specified in application development may not be all available at runtime (i.e., the time at which the CGRS executes the application, or portions of the application). For example, an application can specify use of a particular memory based on a particular CGRP being available at runtime to process data stored in that memory. However, at runtime that particular CGRP may be allocated to another application and the runtime processor may have to allocate an alternative CGRP. Accessing the data in the specified memory may be inefficient for processing by the alternative CGRP, and can then require transferring the data from the specified memory to an alternative memory better suited to processing by the alternative CGRP. Additionally, or alternatively, owing to an abstraction of the CGR hardware in the programming language or SDK, at runtime a particular CGR hardware resource (e.g., a particular processing unit or memory of the CGRS) may not be actually the most optimal, or efficient, to execute the application, or an operation or stage of the application. Thus, to achieve execution objectives of the application a runtime processor may determine that CGR hardware, alternative to those specified based on the abstract representation of the hardware, are best suited. Utilization of these preferred resources can conflict with other CGR hardware specified, based on the CGR hardware abstraction, in the application.

While it is desirable to provide an application developer with a level of abstraction of CGR hardware, it is also desirable and, often necessary, for a CGRS to dynamically (at runtime) allocate CGR hardware to application execution that can optimally meet application execution objectives, and/or optimize execution efficiency. It is particularly desirable, to optimize application execution against application execution objectives, for a CGRS to be able to dynamically select particular memories, and/or methods/hardware resources to transfer stage data among various memories of a CGRS.

In implementations, a CGRS can include a “Dynamic Transfer Engine” (DTE). A DTE can intelligently choose the most efficient data transfer channel dynamically among devices, such as host computers, CGRS processing units such as CGRPs, and/or network storage, for example, based on factors such as the bandwidth, latency, transport, and hardware resource availability of CGR hardware to perform the transfers. A DTE can analyze application specifications, and/or suggestions, of particular memories to store stage data and, at runtime, can determine and manage physical memories of a CGRS in which to store stage data for access by CGRPs to process stage data and/or are, at runtime, available to execute the application.

A DTE can (“intelligently” and dynamically) select particular source and/or destination memories based on, for example, available or suitable memory types; performance characteristics of the memories, such as access latency and/or data rates; data transfer latencies associated with the memories; and/or particular CGRPs allocated at runtime to execute application computations. A DTE can intelligently and dynamically select particular source and/or destination memories based on, for example, hardware topologies and interconnections among the CGR hardware, such as types and/or latencies of interconnections among memories and/or processing units; methods of transferring data among the memories; hardware resources, such as I/O interfaces (“links”), DMA engines, and/or address translation windows (ATWs) available to parallelize movement of stage data among source and destination memories; and/or to achieve particular application execution objectives.

Based on the knowledge (e.g., from a CGR hardware specification) of CGR hardware design and information associated with dynamic states of CGR hardware components, a DTE can apply heuristics to determine the best transport method to perform a transfer, allocate the corresponding CGR hardware components, (e.g., from a CGRS resource manager), and program and/or dispatch the corresponding CGR hardware to execute the selected transport method. Knowledge of CGR hardware design can include bandwidth and latency of various transport methods and CGR transport hardware channels. Information associated with Dynamic states of CGR hardware components can include runtime availability of CGR hardware, computational and/or data transfer load balance, and/or hardware topology of dynamically available CGR hardware components.

To increase bandwidth, and/or reduce latency, of stage data transfers a DTE can determine CGR hardware and/or transport methods that can take advantage of multi-pathing of CGR hardware interconnections (e.g., I/O links between CGRPs) to maximize CGR hardware utilization and minimize overall transfer latency, for example. In an auto-parallel data transfer, a DTE can receive a batch of transfer requests from an application, each having potentially different source, destination, size, and transport method parameters and/or specifications. The DTE can attempt to parallelize each of these transfers using multiple I/O paths among source and destination memories and/or CGRPs.

To parallelize local CPU-to-local CPU transfer among CPUs of hosts within a node, or among multiple nodes, a DTE can divide a transfer across multiple I/O paths based on a host source and/or destination memory location (e.g. a location within a NUMA node) and bandwidth available for that host memory, and can choose an optimal number of execution contexts (threads or processes) depending on the CGRS and/or host resources available.

To parallelize transfers among multiple local CGRPs, a DTE can perform DMAs or memory copy on each CGRP independently and concurrently. Each local CGRP can have a separate execution context (thread or process) that, once started by the DTE, continuously starts new transfers as previous ones finish until no more transfers to/from that CGRP are available. Within a transfer of data to a single CGRP, a DTE can configure the transfer to transfer pieces of data in parallel.

A DTE can parallelize transfers to/from multiple remote memory destinations (e.g. remote CPU, remote CGRP, remote storage), by dividing the transfer into smaller portion of data and load-balance transfer of the smaller portions across available remote transport CGR hardware based on bandwidth of, or available to, that remote transport CGR hardware.

As previously discussed, a CGRS can provide a variety of transport methods, and CGR hardware to execute the methods. Basic transport methods can include, for example, programmatic memory copy, memory mapped I/O (MMIO), Direct Memory Access (DMA), and Remote DMA (RDMA). More complex transport methods can include local CPU to CGRP memory with global CGRP memory interleave; local CPU to CGRP memory with local CGRP memory interleave; local CGRP memory to remote CGRP memory transfer; and, CGRP memory to CGRP memory DMA though CGRP endpoint. A DTE can utilize each of these transport methods simultaneously, such that all or any subset of the methods can be performed concurrently using multiple transport channels.

In a local CPU to CGRP memory global CGRP memory interleave method, a DTE can configure a CGRP's memory subsystem as one continuous block of memory. The DTE can apportion non-overlapping memory segments from a larger contiguous memory block, to each of the available local CPU-to-CGRP input/output (TO) links. The DTE can further divide segments by a number of DMA engines, or MMIO address translation windows (ATWs) associated each of a set of CGRP IO links. A DTE can initiate transfer of stage data, in parallel, among multiple DMA engines and/or MMIO ATW so as to maximize use of I/O bandwidth among the I/O links. A DTE can monitor status of the parallel transfers to ensure that transfers across all of the utilized CGRP IO links are complete before communicating to other hardware and/or software components of a CGRS that transfer of stage data is complete.

A local CPU to CGRP memory with local CGRP memory interleave method is similar to the local CPU to CGRP memory with global CGRP memory interleave method, with the exception that a CGRP's internal memory subsystem is divided into separate address spaces for which certain address spaces can offer a latency advantage to specific CGRP internal components, such as compute tiles. This can offer, in effect, a NUMA-like capability for memories internal to a CGRP. In this method, however, the DTE can determine CGRP IO links to use for a transfer based on the physical locality, within the CGRP, of the memory segment. A DTE can monitor status of the parallel transfers to ensure that transfers across all of the utilized CGRP IO links are complete before communicating to other hardware and/or software components of a CGRS that transfer of stage data is complete.

In a local CGRP memory to remote CGRP memory method, to perform DMAs/RDMAs from memories in one CGRP to memories of another CGRP, a DTE can take advantage of multi-pathing among CGRP I/O paths by splitting CGRP memory segments amongst multiple IO paths local to a node (and/or multiple DMA engines/Address Translation Windows of an IO path). A DTE can, for example, prioritize use of lowest cost (e.g., lowest transfer latency, or highest bandwidth/utilization) paths. If a transfer requires, or can use, additional bandwidth, the DTE can add parallel IO channels having with a higher cost. A DTE can monitor status of the parallel transfers to ensure that transfers across all of the utilized CGRP IO links are complete before communicating to other hardware and/or software components of a CGRS that transfer of stage data is complete.

In a CGRP memory to CGRP memory DMA though CGRP Endpoint method, a DTE can configure an intermediary CGRP in “route through mode”, to act as a conduit for DMA/RDMA traffic between source and destination CGRPs other than itself (while, potentially, executing application computations). In this method, the DTE and/or other components of a CGRS initialize CGRP routing tables according to the system CGR hardware topology. The DTE can determine IO cost functions that reflect a transfer cost associated with transferring stage data through the intermediary CGRP, as opposed to point to point connections between source and destination CGRPs, which can have lower CGR hardware hop counts.

The DTE can initialize DMA/RDMA operations to utilize a point to point link directly connected to the intermediary CGRP, and can associate an endpoint (destination) CGRP with an “endpoint ID”, such as a PCIe address, network MAC address, or developer-defined unique address. The endpoint ID can inform the remote IO logic whether to copy data to its local memory (if the endpoint ID is its own endpoint ID), or to forward data to another CGRP (e.g., the intermediary CGRP). The CGRPs treat the endpoint memory region(s) as a single, global memory space. The DTE can determine if the latency cost involving an intermediary CGRP can meet transfer and/or application execution objectives, or whether it the DTE can use the extra route through connections to an intermediary CGRP for multi-pathing.

This method can additionally, or alternatively, use virtual devices allocated a subset of DMA/RDMA engines on the local node I/O links. In enabling virtualization, a CGRS can, for example, communicate routing tables of corresponding physical CGR hardware devices to the DTE to provide a subset of physical 10 paths for DMA/RDMA transfers. Alternatively, virtualization of the I/O paths for a data transfer can be transparent to the DTE.

Implementations can additionally include a “data location framework” (for brevity, hereinafter, simply “framework”). A framework can comprise interfaces to represent CGR hardware (e.g., source/destination memories and/or CGRPs) to a developer, interfaces for an application to specify particular CGR hardware for execution of the application (e.g., specification of particular memories—represented abstractly as “data locations”—to store stage data), and/or interfaces for an application to request to place and/or transfer stage data among source and destination memories of a CGRS.

Such interfaces can comprise programming language constructs, APIs, CLIs, and/or messaging (e.g., request/response messages) interfaces. Such interfaces can include, for example, abstraction constructs to represent CGR hardware and/or structures, such as CGRPs and/or memories, and an application can specify CGR hardware for executing the application using such constructs. A framework can enable, or facilitate, a compiler and/or runtime processor to allocate CGR hardware, and/or a DTE to dynamically determine and/or manage transfer of stage data among memories of the CGRS.

FIG. 5 illustrates an example framework and DTE. FIG. 5 depicts node 500 comprising host 502, which in turn comprises framework 512, and DTE 522. In implementations, node 500 can be a node of a CGRS (not shown in FIG. 5), such as a node similar or equivalent to nodes in the examples of Kumar, and host 502 can be, for example, a host computing system similar or equivalent to a host computing system as illustrated by the examples of Kumar. In further reference to FIG. 5, for purposes of illustrating the example, reference to “the CGRS” can be understood to refer to a CGRS that includes node 500.

Framework 512 can comprise a data location framework, such as previously described, for an application developer to specify placement of data during application execution using a data location abstraction, and DTE 522 can comprise a Data Transfer Engine to intelligently locate and/or transfer data among memories of the CGRS (e.g., memories included in node 500 and/or components of node 500) during execution of an application on the CGRS.

Host 502 can host development and/or execution of a dataflow application. FIG. 1 depicts host 502 further including RTP 520, APP 510, and compiler 518. In implementations RTP 520 can comprise a runtime processor similar or equivalent to a runtime processor such as illustrated by the examples Kumar. APP 510 can comprise a dataflow application to execute on reconfigurable resources of the CGRS that includes node 500. Compiler 518 can comprise a dataflow compiler to compile APP 510 to execute on the CGRS.

In FIG. 5, host 502 is shown including CPU 524, MEM 526, and local fabric interface LIF 534A. In implementations MEM 526 can be any of a variety of memory types (e.g., SRAMs, DRAMs, ROMs, NVRAMs) and/or organization (arrays of memories, and/or hierarchical memories, such as caches). MEM 526 can store application programs, stage data, programs and/or data of framework 512, compiler 518, RTP 520, and/or DTE 522. MEM 526 can be a source memory and/or a destination memory for stage data processed in the CGRS executing APP 510.

CPU 524 can execute programs of software components of host 502, such as programs of compiler 518, framework 512 (e.g., programs of API 514 and/or SDK 516), RTP 520 (e.g., programs to execute APP 510 on a CGRPs of node 500 and/or additional nodes of the CGRS), and/or programs of DTE 522 (e.g., programs to determine memories to retrieve and/or store stage data and/or transfer methods among memories).

FIG. 5 depicts node 500 further comprising CGRP 504A and CGRP 504B (collectively, “CGRPs 504”), HPM 506, bridge 550, storage 560, RIF 554, and local fabric 540. In implementations, HPM 506 can comprise a high performance memory. A high performance memory can comprise, for example, a memory having a high bandwidth, and/or low access latency. Storage 560 can comprise a storage device of host 502, such as a hard disk drive, optical drive, flash drive or SSD, or combination of any of these. Storage 560 have a higher data storage capacity, for example, and/or can have a higher access latency or lower bandwidth, compared to other memories of host 502 and/or node 500.

CGRP 504A and/or CGRP 504B can be reconfigurable resources of a CGRS to execute operations of APP 510. CGRP 504A and/or CGRP 504B can comprise CGRPs configurable to perform computations, and/or stage data transfers, to execute APP 510. CGRP 504A and/or CGRP 504B can be, for example, CGRPs similar or equivalent to CGRPs described in the examples of Prabhakar, Grohoski, and Kumar. CGRP 504A and CGRP 504B can be similar or equivalent to each other, or can be different (heterogeneous) CGRPs.

FIG. 5 further depicts CGRP 504A comprising MEM 530A and CGRP 504B comprising MEM 530B. MEM 530A and MEM 530B (collectively, “memories 530”) can be any type and/or organization of memories, such as SRAMs, DRAMs, non-volatile memories, scratchpad memories, on-chip memories of a CGRP chip, off-chip memories of a CGRP chip, PMUs, arrays of PMUs, and so forth. CGRP 504A and CGRP 504B can be configurable to process stage data stored in respective memories MEM 530A and/or MEM 530B, and/or to transfer stage data to/from respective memories MEM 530A and MEM 530B. Accordingly, memories 530 can comprise any type and/or organization of memories suitable for CGRPs 504 to process stage data stored in the memories, and/or to store stage data for transfer to or from other memories of node 500 and/or other nodes that can comprise the CGRS.

In implementations a local fabric can interconnect hardware components of a node of a CGRS. A local fabric can comprise interconnections, and/or combinations of interconnections, to couple hardware components within a node of a CGRS. A local fabric can comprise circuit and/or packet switches, I/O bus and/or I/O links and/or bridges, local area networks, and so forth. As used herein, the term “local” refers to a relationship of components within a node (or, more broadly, a distinct subsystem) of a CGRS to each other as coupled by an intervening “local” (within the node or subsystem) interconnection fabric, such as local fabric 540. Components within node 500 can be said to “local” to each other. U.S. Patent Application No. 63/708,899, titled “HEAD OF LINE MITIGATION IN A RECONFIGURABLE DATA PROCESSOR”, to Shah, et al (hereinafter, “Shah”) describes example local fabrics suitable for interconnecting hardware units within a node and among nodes of a CGRS.

In the example of node 500, local fabric 540 can comprise a local fabric, such as just described, to interconnect host 502, CGRPs 504, HPM 506, bridge 550, and storage 560 within node 500. Host 502, CCRP 504A, CGRP 504B, HPM 506, and storage 560 each include respective local fabric interfaces LIF 534A, LIF 534B, LIF 534C, LIF 534D, and LIF 534E (collectively, “LIFs 534”). Local fabric links 542A, 542B, 542C, 542D, and 542E (collectively, “links 542”) connect respective LIFs among LIFs 534 to local fabric 540, and LIFs among LIFs 534 can comprise interface hardware and/or software to transfer data through local fabric 540.

In example systems of Shah, a local fabric can be, or can comprise, for example, a top level network (TLN) to interconnect components (e.g., CGRPs, host/runtime processors, memories, tiles, etc.) within a node, and/or to interconnect components within one node to components (including TLNs) of other nodes of a CGRS. In FIG. 5, local fabric 540 can comprise a TLN and components within node 500 can be said to “local” to each other as coupled by local fabric 540 comprising a TLN.

As illustrated in example systems of Kumar, a CGRS can comprise a plurality of nodes such as node 500. The nodes can be interconnected via one or more “remote” interconnection fabrics. As used herein, the term “remote” refers to a relationship of one node (or, more broadly, one distinct subsystem), and components therein, of a CGRS to other nodes (or, distinct subsystems), and components therein, to others as coupled by an intervening interconnection fabric. For example, in a CGRS having two nodes, A and B, interconnected by a remote fabric, from the perspective of node A, and components therein, node B, and components therein, can be considered “remote”, and vice versa. A remote fabric can facilitate, for example, transfer of stage data among nodes, and/or components of nodes (e.g., among memories and/or CGRPs of the nodes).

In implementations, a remote fabric can comprise a combination of I/O buses and/or I/O links, and/or a network. For example, a remote fabric can comprise PCI buses and bridges, and/or PCI-Express (PCI-E) buses, links, and/or switches. The PCI/PCI-E buses, bridges, links, and switches can form a remote fabric to couple hardware elements of nodes of a CGRS. In another example, a remote fabric can comprise InfiniBand (IB) links and/or switches. The IB links and switches can form a remote fabric to interconnect hardware elements of nodes of a CGRS. Nodes of the CGRS can utilizes the PCI/PCI-E and/or IB components, for example, to transfer stage data among the nodes, and/or components of nodes.

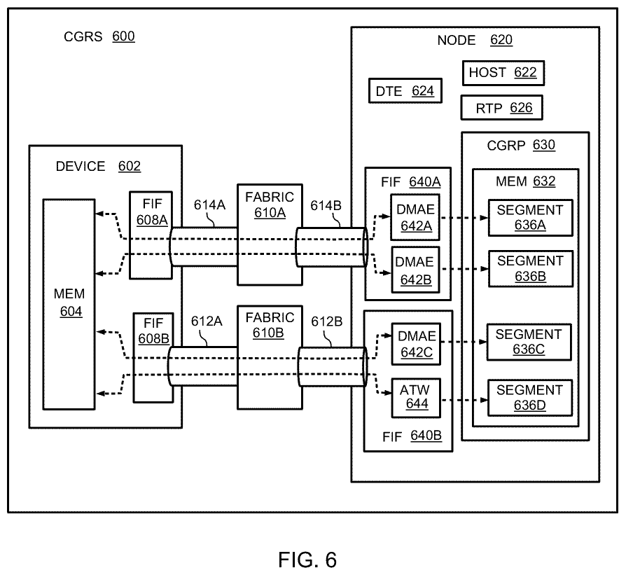

Nodes of a CGRS can include remote fabric interfaces to couple a node, or components therein, to a remote fabric. In FIG. 5 RIF 554 can be a remote interface to couple local fabric 540, via link 556 and link 558, to a remote fabric (not shown in FIG. 1, but described in more detail in the example CGRS of FIG. 6). In FIG. 5 link 556 connects RIF 554 to local fabric 540, and via local fabric 540 RIF 554 can enable other units of node 500, connected to local fabric 540, to further communicate with other nodes of the CGRS via a remote fabric to which RIF is connected via interface 558. As shown in FIG. 5, RIF 554 can be a remote interface to couple local fabric 540 to a remote fabric. However, this is for purposes of illustrating the disclosure and not intended to limit implementations. It will be understood by one or ordinary skill in the art that an RIF can be coupled to, or included in, any component, or combination of components of a node.

In some implementations, a remote fabric can comprise a “direct” interconnection of two or more nodes via links between local fabrics of the nodes. To illustrate, in FIG. 5 bridge 550 can be a bridge between local fabric 540 and a similar, or equivalent, local fabric of another node. Link 546 connects bridge 550 to local fabric 540 and link 552 can couple bridge 550 and, thereby, local fabric 540, to a local fabric, or to a bridge similar or equivalent to bridge 550, of another node of the CGRS, not shown in FIG. 5. Via bridge 550 and link 546 and link 552, components of node 500 (e.g., memories of host 502, CGRPs 504, HPM 506, and/or media 538 of storage 560) can, for example, transfer stage data to/from similar or equivalent components of other nodes (and/or components of other nodes not included in node 500).

In some implementations, two local fabrics can be even more directly coupled by a point-to-point link, omitting a bridge, illustrated in FIG. 5 as link 548. Link 548 can directly connect to a local fabric or, alternatively, to a bridge coupled to a local fabric, of another node. Via link 548 components of node 500 can, for example, transfer stage data to/from similar or equivalent components of other nodes (and/or components of other nodes not included in node 500). A local fabric can include a link interface (not shown in FIG. 5) to links among links 542, link 546, link 548, and/or link 556.

Turning to details of framework 512, FIG. 5 illustrates framework 512 comprising API 514 and SDK 516, which can be a framework such as previously described. In implementations, API 514 can include programming language constructs, APIs, CLIs, and/or messaging (e.g., request/response messages) interfaces to represent the CGR hardware to a developer, to communicate selection of particular CGR hardware for execution of the application, and/or to request to locate and/or transfer stage data among source and destination memories of the CGRS.

Similarly, SDK 516 can include constructs to represent and/or identify CGR hardware. SDK 516 can include interfaces and/or functions for an application, and/or developer, to determine characteristics of the CGR hardware, such as topological locality of CGR hardware, and/or performance characteristics of the CGR hardware. API 514 and/or SDK 516 can include interfaces and/or functions for an application, and/or developer, to specify selected and/or preferred CGR hardware to execute APP 510.

Framework 512 can include programming language constructs, and/or interfaces or functions of API 514 and/or SDK 516, for example, to identify application execution objectives and/or constraints. Application execution objectives can include, for example, a maximum amount of time (execution latency) to execute an application, and/or execute particular portions of an application. Application execution objectives can include selection of particular CGR hardware to minimize cost of executing the application, and/or to increase utilization of CGR hardware used to execute the application. Application execution objectives can include selection of particular types and/or capacities (e.g., size of memories, or processing bandwidth or latencies) of CGR hardware.

Application execution objectives can include minimizing (or, alternatively, maximizing) an amount of stage data stored in one or more particular memories, and/or minimizing or balancing transfer latencies to move stage data from source memories to destination memories. In one context, balancing transfer latencies can correspond, for example, to selecting source/destination memories, and/or hardware to perform stage data transfers, such that transfer latencies between source and destination memories optimizes (e.g., does not stall or delay) progression of stage data and/or computations among pipeline CGRS execution units (e.g., stages within a pipeline of a CGRP and/or stages of a pipeline formed by a plurality of CGRPs).

Application execution constraints can include constraints on CGRS hardware, and/or transfer of stage data among CGRS hardware, used in the CGRS executing an application. For example, an application constraint can direct the CGRS to not utilize particular CGR hardware (e.g., to save execution cost, and/or to optimize one or more execution parameters). An application constraint can limit a CGRS to use only particular types of CGR hardware, such as using only particular source/destination memory types and/or CGRP types (e.g., particular types or configurations of PCUs/PMUs in a tile). For example, an application constraint can limit a CGRS to utilizing only high performance memories, such as on-chip, high bandwidth/low latency, or memories locally close to processor, in executing the application. As application execution constraint can limit a CGRS to not use, for example, a host or network memory, or to not use a storage device (e.g., a magnetic or optimal medium) in executing an application.

These examples of application execution objectives and constraints are, however, only for purposes of illustrating the disclosure and not intended to limit implementations. It will be appreciated by one of ordinary skill in the art that, in implementations, application execution objectives and constraints can include a variety of alternative objectives and/or constraints that can correspond to preferred, or optimal, aspects of a CGRS executing an application.

Turning to details of DTE 522, DTE 522 is shown included in host 502 and coupled to RTP 520 via interface 532. In an alternative implementation, DTE 522 can be a component of node 500 other than a component of host 502, or can be included as a component of RTP 520. DTE 522 can comprise a processor, specialized hardware circuits, and/or software. Programs of DTE 522 can execute, for example, on CPU 524, a CPU of RTP 520 (not shown explicitly in FIG. 5) and/or processing units of the CGRS, such as among CGRPs 504.

DTE 522 coupled to RTP 520 can facilitate interaction between DTE 522 and RTP 520, while executing APP 510 on the CGRS, to enable DTE 522 to determine, during runtime, memories for placing stage data, and/or to transfer of stage data among such memories and/or processing units of node 500 or other components of the CGRS (not shown in FIG. 5), such as other nodes, or components of other nodes, of the CGRS. In implementations interface 532 can comprise, for example, a software interface, such as an API, messaging interface and/or protocol, synchronization primitives (e.g., thread locks/blocks), and/or interrupts. Interface 532 can comprise hardware circuits, status/control registers/bits, signaling and/or communications interfaces, and/or any combination of such elements suitable for enabling DTE 522 to communicate with RTP 520 during execution of APP 510 on the CGRS.

FIG. 5 illustrates DTE 522 coupled to LIFs 534, local fabric 540 and bridge 550 via interface 544. Using interface 544, DTE 522 can determine status (e.g., operational states) of LIFs among LIFs 534, bridge 550, local fabric 540 (and/or link 548). Using interface 544, DTE 522 can configure LIFs among LIFs 534, bridge 550, local fabric 540 (and/or link 548) to transfer data among memories of node 500 and/or memories of remote nodes. Interface 544 can comprise hardware circuits, status/control registers/bits, signaling and/or communications interfaces, and/or any combination of such elements suitable for enabling DTE 522 to couple to components of a node so as to configure, control, and/or monitor operations of the components.

A DTE can associate abstract representations of CGR hardware, such as can be included in a framework of a CGRS, with physical CGR hardware to execute an application. In FIG. 5, framework 512 can include abstract representations of CGR hardware of a node, such as memories, CGRPs, and/or storage of a node, and DTE 522 can associate the abstract representations of CGR hardware with physical CGR hardware (e.g., MEM 526, MEM 536, memories 530, CGRPs 504, and media 538) to execute APP 510. DTE 522 can associate the abstract representations of components of nodes with interconnections (e.g., link 548, bridge 550, and/or RIF 554 of node 500) that couple physical resources of one with physical resources of another node (e.g., a remote node of the CGRS coupled to node 500).

DTE 522 can receive (e.g., from RTP 520, a CGRP among CGRPs 504, and/or other processors and/or hardware of the CGRS) a transfer stimulus (e.g., a request message, a logic signal, data communication, software synchronization primitive, or an interrupt) to transfer stage data stored in a particular, source memory to an alternative, destination memory. The transfer stimulus can be associated with preparing a CGRS to execute an application, and/or can be associated with runtime execution of the application. The transfer stimulus can, for example, locate stage data in a memory best, or better suited to processing the data, and/or to locate stage data in an alternative memory to free the source memory, or portions of the source memory.

A transfer stimulus can comprise a request, such as a request message, to DTE 522 to perform a transfer of stage data from one memory to another. For example, DTE 522, in FIG. 5, can receive a request from APP 510, and/or RTP 520 managing execution of APP 510, to transfer stage data stored in a source memory of node 500 (e.g., MEM 526 of host 502) to MEM 530A of CGRP 504A prior to, or during, CGRP 504A executing operations of APP 510. DTE 522 can receive a request to transfer stage data stored in MEM 530A of CGRP 504A to MEM 526 of host 502, MEM 530B of CGRP 504B, media 538 of storage 560, and/or MEM 536 of HPM 506.

A transfer stimulus can comprise a DTE determining to transfer stage data stored in a source memory of a node to a destination memory of that or, another, node in association with a CGRS preparing to execute an application (e.g., APP 510), in association with a CGRS initiating execution of an application, in association with a CGRS suspending and/or resuming execution of an application, and/or in association with a CGRS completing or terminating execution of an application. A transfer stimulus can comprise a DTE determining to transfer stage data in response to, or associated with particular processing elements (e.g., one or more particular CGRPs) initiating processing, processing, and/or completing processing of computations and/or stage data transfers of the application. For example, during runtime execution of APP 510, in response to, or associated with, CGRP 504A performing, or completing operations of APP 510, DTE 522 can determine to transfer stage data stored in (source) MEM 530A of CGRP 504A to (destination) MEM 530B of CGRP 504B, MEM 526 of host 502, MEM 536 of HPM 506, and/or media 538 of storage 560.

In implementations, a framework can include application execution objectives and/or constraints and a DTE can receive the objectives/constraints at application runtime (or, as part of initiating/resuming application execution). A compiler and/or SDK can analyze an application and can output execution suggestions to a DTE as to memories best suited for execution the application, or executing particular portions of the application. A framework can comprise such suggestions.

Application execution objectives/constraints, and/or compiler/SDK execution suggestions can be included as execution meta-data associated with the CGRS executing the application. A DTE can derive what are the available transport methods from the metadata associated with transfer of stage data, such as meta-data describing source and destination hardware device types, describing memory addresses on source and destination end of the transfer, describing the location of source and destination hardware devices in the transport hardware topology, etc.

Execution meta-data can be an output, for example, of a compiler (e.g., compiler 518 in FIG. 5), output of an SDK (e.g., SDK 516), and/or output of a runtime processors (e.g., RTP 520). Meta-data can include particular transport methods specified by a developer or application, suggested by a compiler/SDK and/or runtime processor. Transport methods include in meta-data can comprise, for example, direct memory access (DMA); remote DMA; memory mapped I/O (MMIO); specialized methods, such as direct unit-to-unit (e.g., CGRP to CGRP); and/or network methods, such as media access and/or network protocol (e.g., TCP/IP) methods.

A DTE can receive, or access, execution meta-data in runtime data, such as configuration/execution data (e.g., a CGRS configuration and/or execution file), and/or in data communicated from a runtime processor to the DTE. A DTE can receive the execution meta-data at application runtime (or, as part of initiating/resuming application execution).

A transport specification and/or a suggestion, can include an abstract representation of a source and/or destination memory and a DTE can select physical memories of a CGRS based on the abstract representations. A DTE select a destination memory based on the objectives/constraints (e.g., to optimize execution in view of an objective, or to not select a destination memory based on a constraint), and/or compiler/SDK suggestions.

In response to a transfer stimulus a DTE, such as DTE 522, can initiate and manage transfers of stage data among the memories (and/or other components of a node such as node 500, or a remote node of a CGRS). DTE 522 can select particular destination memories to receive the data/results, and/or can select particular CGRS hardware, and associated transfer methods, to perform the transfer. A DTE can select a destination memory based on a variety of criteria. A DTE can select a destination memory based, for example, on aspects of CGR hardware such as configurations of CGR hardware components, availability of CGR hardware components, topologies of CGR hardware components, and/or performance characteristics of CGR hardware components. A DTE can determine to perform a transfer based on these aspects in light of execution objectives, constraints, and/or suggestions, and/or select CGR hardware components to transfer stage data best, or better, suited to these objectives, constraints, and/or suggestions.

In addition, or alternative to, selecting a destination memory based on application execution objectives, constraints, and/or suggestions, a DTE can select a destination memory based on a source memory associated with the transfer, CGR hardware available to perform the transfer, and/or based on characteristics of CGR hardware available to perform the transfer. For example, based on stage data stored in a source CPU memory (e.g., MEM 526 of node 500), DTE 522 can determine to transfer stage data to a destination memory of a CGRP (e.g., MEM 530A of CGRP 504A), so as to locate the stage data in a memory more suitable (e.g., having higher performance) for the CGRP to process the stage data.

A DTE can select a destination memory based on characteristics or attributes of a destination memory. For example, in node 500 of FIG. 5, DTE 522 can select MEM 536 as a destination memory in lieu of MEM 526 based on MEM 536 having higher transfer bandwidth or lower access latency compared to MEM 526. Alternatively, for example, DTE 522 can select MEM 526 as a destination memory in lieu of MEM 536 based on MEM 526 having greater storage capacity (e.g., number of memory words) compared to MEM 536.

A DTE can select particular CGR hardware components, and a method to perform a transfer between source and destination memories or other CGR hardware components, based on factors such as the design and/or architecture of CGR hardware, and/or CGR hardware components available to execute the transfer. A DTE can select CGR hardware components to perform a transfer based, for example, on bandwidth or latency of available hardware resources, and/or of a source and/or destination memory. A DTE can select CGR hardware components based on locality of the resources (e.g., hardware “hops”) relative to source and/or destination memories. A DTE can select CGR hardware components, and/or a method to perform a transfer, based on information (e.g., preferred transfer methods and/or hardware) included in, for example, execution meta-data.

Methods of transferring stage data, such as previously described, among memories, CGRPs, and/or other CGR hardware can correspond to selection of particular hardware to perform the transfer. A method of transferring stage data can correspond to the particular type of memories and transfer hardware, and/or resources of the transfer hardware. For example, hardware of a CGRS (e.g., local fabric interfaces) can transfer data using direct memory access (DMA) among memories within a node, remote DMA (RDMA) among memories of differing nodes, memory mapped I/O (MMIO) copy between memories, I/O bus and/or I/O link methods (e.g., PCI/PCI-E and/or IB methodologies), memory coherency methods (e.g., such as Open CAPI methods), and/or network protocols (e.g., media access, a “MAC” protocol, internet protocol, “IP”, and/or transfer control protocol, “TCP/IP”).

CGR hardware available to perform a transfer can comprise varying hardware resources to perform a transfer. For example, hardware to perform DMA, or RDMA, can comprise one or a plurality of DMA engines and/or channels. Hardware to perform MMIO copy can comprise one or a plurality of Address Translation Windows (ATWs) to map source and/or destination memory locations. Hardware to perform IO bus and/or I/O link DMA can comprise one or a plurality of ATWs to map I/O bus and/or I/O link addresses to source and/or destination memory locations. Hardware to perform network protocols can comprise one or more network channels or network interface links (e.g., virtual NIC functions, virtual LANs, etc.). A DTE can select a method to transfer stage data between memories based on the types and/or number of such resources, and/or comparative performance characteristics (e.g., bandwidth or transfer latency) of such resources.

In implementations a DTE can utilize a plurality of such hardware resources concurrently to perform a transfer. Utilizing a plurality of concurrent hardware resources is referred to herein as “multi-pathing” of a stage data transfer. A DTE can select particular hardware resources, and corresponding transfer methods, based on the hardware resources and/or methods being available and capable of multi-pathing.

FIG. 6 illustrates an example of CGR hardware having multiple hardware channels to transfer stage data among memories/CGRPs within a node, and/or between nodes, of a CGRS. In FIG. 6 CGRS 600 is shown comprising node 620 and device 602. Node 620 can be, for example, a node similar or equivalent to node 500 of FIG. 5, or a node as illustrated in the examples of Grohoski and Kumar. Node 620 is shown in FIG. 2. comprising host 622, DTE 624, RTP 626, and CGRP 630. In implementations host 622 can be similar or equivalent to host 502 in FIG. 5; DTE 624 can be similar or equivalent to DTE 522 of FIG. 5; and/or RTP 626 can be a runtime processor similar or equivalent to RTP 520 of FIG. 5. CGRP 630 is shown further comprising memory MEM 632. In implementations host 622 can be, for example, similar or equivalent to host 502 in FIG. 5, and DTE 624 can be similar or equivalent to DTE 522 in FIG. 5. CGRP 630 can be similar or equivalent to CGRP 504A in FIG. 5, and MEM 632 can be similar or equivalent to mem530A of CGRP 504A in FIG. 5.

Device 602 can be a device having data to transfer to or from node 620. Device 602 can be, for example, a component of a node similar or equivalent to node 500, such as a host computer (e.g., host 502), a CGRP (e.g., CGRP 504A), a high performance memory (e.g., HPM 506), or a storage system (e.g., storage 560) or device (e.g., a hard drive or optical disk). Device 602 can comprise a GPU or FPGA, and/or specialized computational and/or storage (e.g., memory) circuits, such as a signal processor or other ASIC. Device 602 is shown in FIG. 6 comprising memory MEM 604, which can be a memory of a component of a node, such as memories of components of node 500 in FIG. 5. MEM 604 can store data to transfer to or from node 620.

FIG. 6 further illustrates node 620 and device 602 coupled via fabrics 610A and 610B (collectively, “fabrics 610”). In FIG. 6, node 620 is shown further comprising fabric interfaces FIF 640A and FIF 640B and device 602 is shown further comprising fabric interfaces FIF 608A and FIF 608B.

In implementations, fabric 610A and/or 610B can be local, such as local fabric 540 in FIG. 5, and/or remote fabrics. A remote fabric can comprise a network to couple, for example, local fabrics, and/or other hardware components, of differing nodes of a CGRS. FIF 640A and FIF 640B can couple node 620 to fabric 610A and 610B via respective fabric links 614B and 612B, and FIF 608A and FIF 608B are shown coupling device 602 to fabric 610A and 610B via respective fabric links 614A and 614B, and 612A and 612B. Via fabrics 610 and the associated fabric interfaces and links of host 622 and device 602, a DTE can transfer stage data, for example, from MEM 632 of node 620 to MEM 604 of device 602, or vice versa. In implementations, fabrics 610 can be local fabrics, remote fabrics, and/or interconnections of local fabrics (e.g., array level networks of a tile coupled by a TLN) and/or remote fabrics, such as previously described.

Types and/or combinations of hardware transfer resources can form a “transfer channel”. In implementations a transfer channel can comprise, for example hardware components of a node, such as link interfaces (e.g., PCI/PCI-E adapters, IB adapters, Open CAPI adapters, local fabric bridges, local fabric direct links, network interfaces—“NICs”—etc.), DMA engines, MMIO engines/processors, links, and/or fabrics. Hardware of a transfer channel can be included in link interfaces (as in the example of FIG. 2) and/or can be separate from and coupled to link interfaces. In FIG. 6 FIF 640A is shown comprising DMA engines DMAE 42A and DMAE 642B, and FIF 640B is shown comprising DMA engine DMAE 642C and ATW 644. DMA engines DMAE 642A, DMAE 642B, and DMAE 642C (collectively, “DMA engines 642”) and/or ATW 644, in combination with FIF 640A and FIF 640B and their associated fabric links (614A and 614B, and 612A and 612B) and fabrics 610 can form transfer channels. In implementations, DTE 624 can utilize transfer channels including DMA engines 642C and/or ATW 644 to transfer stage data between MEM 632 and MEM 604. In implementations a DTE (or, other components of a CGRS) can compute, or associate, an I/O cost with a transfer channel. A DTE can select a destination memory, transfer channel, and/or transfer method based on comparative I/O costs among them.

A DTE can configure source/destination memories based on transfer channels available for the DTE to utilize to transfer stage data between them. For example, as shown in FIG. 6, DTE 624 can configure MEM 632 as a continuous block of memory and can allocate non-overlapping segments of MEM 632, shown in FIG. 6 as segments 636A, 636B, 636C, and 636D. DTE 624 can allocate the segments to correspond to the type and/or number of transfer channels of node 620 to transfer data between MEM 632 and MEM 604. As seen in the example of FIG. 6, DTE 624 (and/or, host 622) can allocate segments among segments 636A, 636B, 636C, and 636D based on FIF 640A having 4 available transfer channels: 3 DMA engines among DMA engines 642 and ATW corresponding to ATW 644. While not shown in FIG. 2, DTE 624 can additionally, or alternatively, configure MEM 604 to have separate address spaces for regions of MEM 604 that can have a latency advantage to particular processing components of node 620 (e.g., a latency advantage for particular tiles, and/or PCUs/PMUs of tiles, of CGRP 630). Also, while not shown in FIG. 6, FIF 608A and FIF 608B of device 602 can include DMA engines/ATWs to form a transfer channel. DTE 624 can configure transfer channels in either or both of device 602 and node 620 to execute a transfer of stage data between MEM 604 and MEM 632.

In implementation DTE 624 can configure a memory (or, memories) of a node, such as a memory (or, memories) of CGRP 630, as separate address spaces and can allocate segments of the address spaces to execute a transfer of stage data between that and other memories. In such a case, certain address spaces can have a performance advantage (e.g., latency or throughput) compared to others. Such advantages can be based on locality of a memory segment, located in a particular address space, relative to a source/destination memory and/or hardware of a transfer channel to execute a transfer. DTE 624 can configure the memory address spaces and/or segments, and select particular transfer channels, based on such advantages.

DTE 624 can select a transfer channel, and/or multiple transfer channels of node 620 (and/or device 602) in any particular combination, based on available transfer channels. DTE 624 can select a transfer channel, and/or multiple transfer channels that can, for example, effect the transfer in accordance with execution objectives, constraints, and/or suggestions. To illustrate further, DTE 624 can select a combination of DMA engines, among DMA engines 642, and ATW 644 based on transfer channels including these resources being available—at application runtime, for example—to execute the transfer.

DTE 624 can initiate a multi-path transfer of stage data, using multiple available transfer channels, between MEM 604 and MEM 632 to overlap the transfers, For example, DTE 624 can initiate a transfer of stage data between MEM 604 and segment 636A, in MEM 632, using DMA 642A and a concurrent transfer of stage data between MEM 604 and segment 636B, in MEM 632, using DMA 642A. DTE 624 can initiate a transfer of stage data between MEM 604 and segment 636A, in MEM 632, using all DMA engines of DMA engines 642 concurrently, and/or transfer of stage data between MEM 604 and segment 636B, in MEM 632, using DMA 642B. DTE 624 can monitor status of each of the transfer channels to determine when each transfer channel has completed its respective portion to transfer stage data between MEM 604 and MEM 632.

A DTE can select one or more available transfer channels to transfer stage data based on methods of transfer corresponding to a type or design of hardware included in the transfer channel(s). For example, a DTE can select a transfer channel comprising FIF 640A, and not select a transfer channel comprising FIF 640B, based on FIF 640A having DMA engines 642A and 642B and FIF 640B having only one DMA engine (642C) or utilizing MMIO via ATW 644 (which can be longer transfer latency and/or involve more processing resources, compared to DMA).

Similarly, DTE 624 can select a transfer channel comprising FIF 640A, for example, based on fabric 610A comprising local fabrics of device 602 and node 620 coupled by a bridge or direct local fabric link, such as link 548 in FIG. 5. In some implementations, a CGRS can comprise, or can be coupled to, network attached storage (NAS) and can transfer stage data between nodes of the CGRS (e.g., memories of the nodes) and media (e.g., a magnetic or optical disk, or SSD) of the NAS. In such a system, DTE 624 can select a transfer channel comprising FIF 640B, for example, based on fabric 610B comprising a remote fabric coupled to a NAS medium to transfer stage data to/from the NAS storage medium.

As discussed earlier, DTE can receive a set, or batch of transfer requests, and each request can comprise differing source and/or destination memories, different transfer sizes (e.g., number of bytes), and/or transport methods. A DTE can utilize multiple transfer channels to parallelize transfers of data among a batch of requests, such as to increase or optimize utilization of CGR hardware, and/or to minimize transfer latency.

A CGRS can comprise a plurality of nodes (e.g., connected by a remote fabric and/or bridges/direct links between local fabrics) and multiple nodes of the CGRS can execute portions of an application (e.g., as a processing pipeline or as distributed, parallel processors). A DTE can transfer stage data among memories of multiple nodes and can utilize criteria such as just described to select CGR hardware and/or methods to perform the transfers.

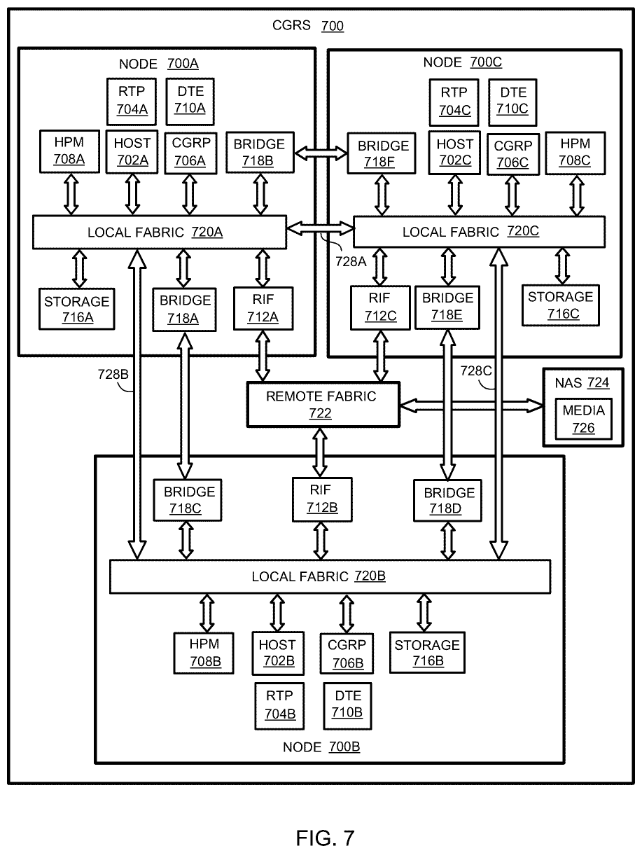

FIG. 7 illustrates example CGRS 700 comprising node 700A, node 700B, and node 700C (collectively, “nodes 700”) coupled by remote fabric 722. In implementations nodes among nodes 700 can be nodes similar or equivalent to node 500 of FIG. 5 or as illustrated in the examples of Grohoski and Kumar, and remote fabric 722 can comprise a remote fabric such as in the example of FIG. 6. Link 728A, link 728B, and link 728C (collectively, “links 728”) can comprise direct local fabric links, such as in the example of link 548 in FIG. 5. As illustrated in FIG. 7, remote fabric 722 can interconnect node 700A, node 700B, and node 700C via respective remote interfaces RIF 712A, RIF 712B, and RIF 712C. FIG. 7 further illustrates remote fabric 722 coupled to NAS 724, which can comprise a network storage system having, or coupled to, a storage medium, shown in FIG. 7 as media 726. Remote fabric 722 can enable node 700A, node 700B, and node 700C to access NAS 724 and/or media 726.

In FIG. 7 each of nodes 700 comprise, respectively, host 702A, host 702B, and host 702C (collectively, “hosts 702”); runtime processors RTP 704A, RTP 704B, and RTP 704C (collectively, “RTPs 704”); and, DTE 710A, DTE 710B, and DTE 710C (collectively, “DTEs 710”). In implementations, hosts among hosts 702 can be hosts such as host 502, and DTEs 710 can be DTEs such as DTE 522, in FIG. 5. In implementations host 622 can be similar or equivalent to host 502 in FIG. 5; DTE 624 can be similar or equivalent to DTE 522 of FIG. 5; and/or, RTP 626 can be a runtime processor similar or equivalent to RTP 520 of FIG. 5. While not shown explicitly in FIG. 7, DTEs among DTEs 710 can be communicatively coupled to other DTEs among DTEs 710, hosts among hosts 702, and/or runtime processors among RTPs 704; hosts among hosts 702 can be communicatively coupled to other hosts among hosts 702A and/or runtime processors among RTPs 704; and, runtime processors among RTPs can be communicatively coupled to hosts among hosts among hosts 702 and/or other runtime processors among other runtime processors among RTPs 704.

In FIG. 7, nodes 700 each include a CGRP: CGRP 706A in node 700A, CGRP 706B in node 700B, and, CGRP 706C in node 700C (CGRPs 706A, 706B, and 706C collectively referred to as “CGRPs 706”). CGRPs among CGRPs 706 can be similar or equivalent to CGRP 104A in FIG. 5, for example. FIG. 7 further illustrates each of nodes 700 comprising a high performance memory (HPM), storage system, and remote fabric interface (RIF), all of which are shown coupled to a local fabric within the respective nodes. HPM 708A in node 700A, HPM 708B in node 700B, and/or HPM 708C in node 700C can be a high performance memory such as the example of HPM 506 in FIG. 5; and, HPM 708A, HPM 708B, and/or HPM 708C can include a local fabric interface to couple to respective local fabric 720A, local fabric 720B, and local fabric 720C. Storage 716A in node 700A, storage 716B in node 700B, and/or storage 716C in node 700C can be a storage system such as the example of storage 560 in FIG. 5. Storage 716A, storage 716B, and/or storage 716C in node 700C can include a local fabric interface to couple to respective local fabric 720A, local fabric 720B, and local fabric 720C.

FIG. 7 illustrates CGRS 700 comprising remote fabric 722 interconnecting nodes 700A, 700B, and 700C, and each of nodes 700A, 700B, and 700C including, respectively, remote fabric interfaces RIF 712A, RIF 712B, and RIF 712C (collectively, “RIFs 712”). Remote interfaces among RIFs 712 can comprise a remote interface such as the example of RIF 554 in FIG. 5, and can couple respective local fabrics 720A, 720B, and 720C to remote fabric 722, to enable nodes among nodes 700 (e.g., components of nodes among nodes 700) to communicate with each other.

Similarly, FIG. 7 illustrates each of nodes 700A, 700B, and 700C including, respectively, bridge 718A and bridge 718B; bridge 718C and bridge 718D; and bridge 718E and bridge 718F. Bridge 718A, bridge 718B, bridge 718C, bridge 718D, bridge 718E, and/or bridge 718F can comprise local fabric bridges such as illustrated in the example of bridge 550 in FIG. 5. Bridge 718A is shown, in FIG. 7, coupled to bridge 718C, such that node 700A and node 700B can communicate via respective local fabrics 720A and 720B; bridge 718B is shown coupled to bridge 718F such that node 700A and node 700C can communicate via respective local fabrics 720A and 720C; and, bridge 718D is shown coupled to bridge 718E such that node 700B and node 700C can communicate via respective local fabrics 720B and 720C.

Also similar to the example of node 500 in FIG. 5, FIG. 7 illustrates nodes 700A, 700B, and 700C coupled by links 728A, 728B, and 728C, which can comprise point-to-point links such as the example of link 548 in FIG. 5. Link 728A is shown, in FIG. 7, coupling local fabric 720A and local fabric 720C, such that node 700A and node 700C can communicate via respective local fabrics 720A and 720C; link 728B is shown coupling local fabric 720A and local fabric 720B, such that node 700A and node 700B can communicate via respective local fabrics 720A and 720B; and, link 728C is shown coupling local fabric 720B and local fabric 720C, such that node 700B and node 700C can communicate via respective local fabrics 720B and 720C.

While the example nodes of FIG. 7 each include a host computer (among hosts 702) a runtime processor (among RTPs 704), and a DTE (among DTEs 710), this is to illustrate the example of CGRS 700 and not intended to limit implementations. In alternative CGRS (or, more broadly, dataflow computing system) implementations a subset of nodes (e.g., only one or two nodes among nodes 700), for example, can include a host computer; a subset of nodes can include an RTP; and/or a subset of nodes can include a DTE.

In a CGRS (or, other dataflow computing system), DTEs among a plurality of DTEs in the system (e.g., DTEs among DTEs 710 in FIG. 7) can each process transfers with respect to stage data stored within, and/or transferred to/from, memories local to their respective nodes. DTEs among a plurality of DTEs can cooperatively select memories, transfer methods, and/or transfer channels, and/or initiate and monitor transfers sing the channels, within and/or among memories of the nodes. A particular DTE among a plurality of DTEs can be a “master” DTE and can select memories, transfer methods, and/or transfer channels, and/or initiate and monitor transfers sing the channels, within and/or among memories of all of the nodes.

Nodes of a CGRS can be configurable to act as a transfer intermediary between two or more other nodes, and to form a transfer channel including the intermediary node. That is, among 3 (or more) nodes of a CGRS one node can act as a “conduit” to pass stage data between memories of 1 node of the 3 and another node of the 3. For example, in FIG. 7 DTE 710A can determine to transfer stage data between a memory of node 700A, for example a memory of CGRP 706A, and a memory of node 700B, for example a memory of CGRP 706B. DTE 710A (optionally, in combination with DTE 710B and/or DTE 710C) can configure a transfer channel of nodes 700A, 700C, and 700B to transfer the stage data between the CGRP 706A and 706B such that the stage data pass through node 700B (e.g., via CGRP 706B, or bridges 718B and 718D of node 700B).

To illustrate in more detail, using the example of transferring stage data between a memory of CGRP 706A and a memory of CGRP 706C via node 700B as a conduit, DTE 710A can configure CGRP 706A, CGRP 706C, and/or components of node 700C (e.g., components of, or coupled to, local fabric 720B in node 700C). For example, DTE 710A can configure routing tables in one or more of local fabrics 720A, 720B, and 720C; in CGRPs 706A and 706C; and/or, in components of node 700C, such as routing tables in bridges 718B and/or 718D. DTE 710A can configure the routing tables based, for example, on hardware types and/or interconnection topologies within CGRS 700. The routing table can, for example, target connections on point to point links between components of the nodes (e.g., a point to point link between a component of nodes 700 and a respective local fabric of nodes 700). The connections can be represented by an identifier or an address of an endpoint, such as a PCIE or MAC address, of a developer-defined identifier such as can be included in meta-data associated with a transfer.

In implementations, an endpoint identifier can inform a node, and/or a transfer channel of a node, whether to serve as a destination for stage data being transferred or to, alternatively, forward the stage data to another node, or component of a node or transfer channel. For example, if a DMA endpoint identifier for a transfer of data from CGRP 706A corresponds to a component of node 700B, upon DMA to node 700B (or, a transfer channel transferring the stage data) node 700B (e.g., routing tables of node 700B) can determine to receive the stage data as the destination of the transfer. Alternatively, if a DMA endpoint identifier for a transfer of data from CGRP 706A corresponds to a component of a node other than 700B, upon DMA to node 700B (or, a transfer channel transferring the stage data) node 700B (e.g., routing tables of node 700B) can determine to forward the stage data to another node, such as 700C.

Implementations can include methods for one or more DTEs to receive a transfer stimulus; to select CGR hardware resources and/or transport methods to transfer stage data among CGR hardware components (e.g., memories, host computers, runtime processors, storage systems and/or devices; and/or CGRPs); and/or to interact with one or more host computers, runtime processors, CGRPs, and/or CGR hardware to imitate and determine states of stage data transfers among CGR hardware components.

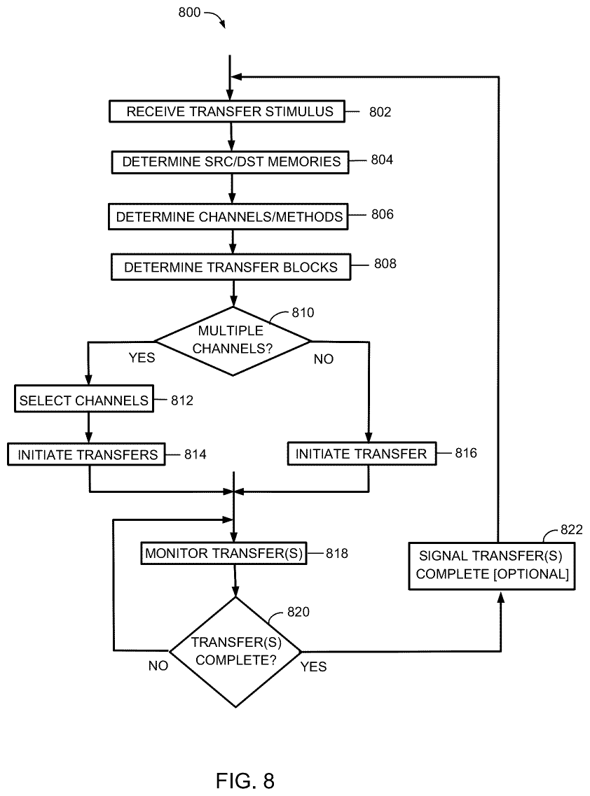

FIG. 8 illustrates example method for a DTE to perform such operations. To illustrate the method, but not intended to limit implementations, method 800 of FIG. 8 is described as performed by a DTE (hereinafter, for purposes of describing the method, “the DTE”), such as described in reference to the examples of FIGS. 5-7. The DTE can be included in a multi-node CGRS (hereinafter, for purposes of describing method 800, “the CGRS”), such as CGRS 700 in FIG. 7. Nodes of the CGRS can comprise nodes such as example node 500 of FIG. 5, and the DTE can utilize one or more transfer channels, such as the example of FIG. 6, to transfer stage data among CGR hardware elements. However, it will be appreciated by one of ordinary skill in the art that the method can apply to, be performed by, and/or utilize, a variety of components of a computing system (e.g., a dataflow computing system) alternative to these examples.

In operation 802 of method 800, the DTE receives a transfer stimulus (hereinafter, with reference to method 800, “the stimulus”) to transfer stage data among CGR hardware elements, such a memories, CGRPs, and/or storage components, of the CGRS. In describing method 800, “memories” refers interchangeably to any memories of, or coupled to, a CGRS, such as CPU memories, memories of CGRPs, memories coupled to local fabrics of nodes of the CGRS, and/or storage media, and/or memories associated with storage media, of the CGRS.

In operation 802 the DTE the stimulus can comprise a transfer stimulus such as previously described. As previously described, a transfer stimulus can comprise, for example, a state of execution of an application by the CGRS, and/or can comprise a transfer request, such as a requests from an application executing on the CGRS, and/or, form or generate by a component of the CGRS, such as a framework of the CGRS, a compiler and/or SDK of the CGRS, and/or a runtime component (e.g., a runtime processor) of the CGRS. A transfer request can include identities and/or characteristics of source and/or destination units of the CGRS (e.g., memories and/or processors units included in a node of the CGRS). Identities and/or characteristics of the source/destination units can include abstractions of CGR hardware, such as types of CGR hardware (e.g., types of memories and/or processors of the CGRS), performance characteristics of the source/destination units, capacities of the source/destination units, and so forth.

In operation 802, if the transfer stimulus includes a transfer request, the request can include meta-data and the DTE can extract the meta-data from the request. As previously described, the meta-data can comprise application execution objectives and/or constraints, compiler and/or SDK suggestions, and/or developer/application and/or CGRS preferred source/destination units of the CGRS. The meta-data can include CGRS hardware abstractions, such as abstractions included in a data location framework of the CGRS. In operation 802, the DTE can extract the meta-data from a memory (e.g., a memory of a host and/or runtime processor) and/or from the request.

In operation 804, the DTE determines, based on the transfer stimulus (e.g., from a request and/or meta-data, or. based on the stage data to be transferred) one or more source memories from which to transfer stage data, and one or more destination memories to receive the stage data. The DTE can determine the source and/or destination memories based on CGRS hardware abstractions included in a request and/or associated with a transfer stimulus. The DTE can interact with a runtime component of the CGRS to determine the source and/or destination memories.

In operation 804 the DTE can determine the source and/or destination memories based on hardware selection criteria. In implementations, hardware selection criteria can be associated with, or related to, CGR hardware, such as memories, transfer channels, and/or transport methods associated with, and/or required, to execute the transfer. Hardware selection criteria can include criteria associated with CGR hardware, such as whether or not particular CGRS memories are available at application runtime, and/or particular CGR hardware (e.g., CGRPs) available or required to process the stage data at application runtime.

Hardware selection criteria can include types of available memories, capacities of available memories; types of data included in the stage data, a location, within the hardware topology of the CGRS, of source and/or destination memories; and/or, a topological location, within the CGRS, or CGR hardware to process the stage data. Hardware selection criteria can include application execution flow of the stage data through units of the CGRS (e.g., flow of the stage data through stages of a CGRP and/or CGRS pipeline). The DTE can determine the source and/or destination memories to balance pipeline stages, such as to manage stage data flow through a pipeline of the CGRS to prevent, or minimize, stalling operations of stages of the pipeline.

Hardware selection criteria can include application execution objectives, such as application execution latency and/or computational throughput, and/or can include constraints associated with CGR hardware to perform the transfers, and/or the transfers themselves. Hardware selection criteria can include execution suggestions included in a transfer request and/or meta-data. Hardware selection criteria can be static, such as output by a data location framework, compiler, or SDK. Hardware selection criteria can be, additionally or alternatively, dynamic, such as criteria associated with dynamic states of the CGRS (e.g., available CGR hardware, and/or utilization of CGR hardware), and/or outputs of a runtime processor.

In operation 806, the DTE determines transport methods and one or more transfer channels that can execute the transfer. Differing source and destination memories, and/or CGR hardware to transfer data between the source and destination memories, can require different transport methods. Particular transport methods can be more efficient than others, to transfer stage data between the source and destination memories. Thus, in operation 806 the DTE determines one or more transport methods, such as previously described, to transfer stage data between the source and destination memories determined in operation 804, based on requirements of the source and/or destination memories, or associated with transferring stage data among the source and destination memories.

A transfer channel can comprise a transfer channels such as described in the examples of FIGS. 2 and 3. The DTE can determine transfer channels based on, for example, the transport method(s) determined in operation 806, and/or hardware selection criteria. In operation 806 the DTE can determine transfer channels based on a number of hardware transfer units associated with the channels, such as a number of DMA engines and/or ATWs associated with a transfer channel. The DTE can determine transfer channels based on performance characteristics of CGR hardware associated with the channels, such as transfer latencies and/or bandwidth associated with a transfer channel. The DTE can determine transfer channels to balance stage data flow through a pipeline of the CGRS.

In operation 806, the DTE can, determine transfer channels based on topological locations of memories hardware transfer units associated with the channels. The DTE can determine transfer channels based on CGR hardware topological proximity of a transfer channel to a source and/or destination memory. For example, the DTE can determine a transfer channel based on the source and destination memory coupled to the same local fabric, or coupled to different local fabrics that are themselves coupled by a bridge or direct link, such as in the example of FIG. 7. The DTE can determine a transfer channel based on a method of transferring stage data (e.g., DMA, RDMA, MMIO, network protocols, or I/O buses/links) between a source and destination memory. The DTE can determine a transfer channel based on availability of such methods, and/or corresponding hardware resources, at a time to transfer the stage data.

In operation 808, the DTE can determine block sizes to execute the transfer. In implementations, block sizes can be a number of bytes, or words, of data of the stage data to transfer in, for example, a particular transfer operation (e.g., a particular DMA or MMIO operation). The DTE dan determine a block size, or sizes, based on a transport method and/or transfer channel(s) determined in operation 806. For example, the DTE can determine a block size to transfer stage data from a particular source memory to a particular destination memory based on a method of transfer associated with a transfer channel, and/or a number of transfer resources (e.g., DMA engines, ATW, network interfaces, etc.) included in a transfer channel. The DTE can determine block sizes to correspond to an organization of a source and/or destination memories, such a memory organized as a single, contiguous memory space or organized as a plurality of individual memory spaces. The DTE can determine block sizes to correspond to segments of a source and/or destination memory.

In operation 810 the DTE determines if there are multiple transfer channels, among the channels determined in operation 806, to execute the transfer. If so, in operation 812 the DTE selects transfer channels from among the channels determined in operation 806. In implementations the DTE can select particular transfer channels, in operation 812, based on, for example, criteria included in hardware selection criteria, execution objectives/suggestions included in the meta-data, to minimize overall transfer latency or maximize overall transfer throughput. The DTE can select particular transfer channels based on flow of stage data through hardware units of the CGRS, and/or to optimize CGR hardware utilization. The DTE can select particular transfer channels based on relative timing among the transfer channels.

In operation 814, the DTE initiates transfer of the stage data, or portions thereof, using the transfer channels selected in operation 812. In implementations, initiating execution of the transfer(s) can comprise, for example, the DTE configuring components of the transfer channels, such as DMA engines, ATWs, source/destination memory and/or network address. Initiating execution of the transfer(s) can comprise the DTE programming routing tables of hardware the CGR hardware (e.g., switch routing tables of a switches in an array level, and/or top level, network) and/or local/remote fabrics. The DTE can initiate transfer stage data among source and destination memories using an interface among components of the CGR hardware, such as interfaces similar to interface 544 in FIG. 5.

Initiating a transfer can comprise sending/receiving protocol messages to/from source and/or destination memories (and/or intermediary CGRS components coupling source and destination memories), such as protocol messages associated with storage media and/or networks. In operation 814, a DTE can initiate a transfer via a communication with a host computing system, and/or runtime processor.

If, in operation 810, the DTE determines that there are not multiple transfer channels (i.e., the DTE determines that there is only a single channel determined in operation 806) to execute the transfer, in operation 816 the DTE initiates the transfer using the transfer channel determined in operation 806. In operation 816, the DTE can initiate the transfer, the single transfer channel, in a manner such as just described in reference to operation 814.

In operation 818, the DTE monitors progress of the transfers initiated in operation 814 or, alternatively, progress of the transfer initiated in operation 816 using the single transfer channel. In operation 818 the DTE can monitor, for example, status indicators included in hardware of the transfer channel(s) to determine that a transfer is complete. The DTE can monitor the status indicators by, for example, polling the indicators periodically. Additionally, or alternatively, the DTE can monitor the status indicators in response to a hardware interrupt associated with a transfer channel. The DTE can monitor the status, in operation 818, by awaiting a logic signal, and/or communication, from hardware of the transfer channel(s), and/or a communication from a host and/or a runtime processor.

In operations 814 and/or 816, initiating transfers can comprise the DTE activating a transfer process, or thread of a transfer process to execute a transfer using one or more particular transfer channels. The transfer process can be, for example, a software process of the DTE, of a host computer (such as 102 in FIG. 5), of a runtime processor, or of a CGRP. Initiating a transfer can further comprise the thread suspending on a software concurrency primitive (e.g., a thread lock, semaphore, or thread block) pending partial or whole completion of the transfer.

In operation 820, based on the monitoring the transfer(s) in operation 818, the DTE determines a completion status of the transfer or multiple transfers. In implementations, a completion status can indicate partial, or whole, completion of a transfer, and/or a status of a transfer channel. If, in operation 814, the DTE initiated multiple transfers, in operation 820 the DTE can determine a collective completion status regarding some or all of the transfers. In operation 818 completion of a transfer, in part or in whole, can operate on a concurrency primitive of a transfer process/thread activated in operation 814 or 816, such as to resume the process/thread. In operation 820, the process/thread can determine, implicitly or explicitly, a completion status of the transfer, or transfer channel.

If, in operation 820 the DTE determines that transfers initiated in operation 814 or operation 816 are complete, the DTE can repeat operations 802-818. If the DTE determines, in operation 820, that the transfers initiated in operation 814 or operation 816 are complete the DTE can determine, for example, that there are additional requests (e.g., requests among a set of requests received in operation 802) to process and, can repeat operations 802-818 to process a transfer among those additional requests. If the DTE determines, in operation 820, that the transfers initiated in operation 814 or operation 816 are complete transfers are complete, in operation 820 the DTE can repeat operation 802 to await, or determine, a transfer stimulus.

In repeating operation 802, in operation 822 the DTE can, optionally, signal completion of the transfer(s). For example, in operation 822 the DTE can communicate to an application, a host or runtime processor, and/or components of a node (e.g., a CGRP, or components of fabrics and/or components of a node coupled to a fabric) that transfers among the transfers initiated in operation 814 or operation 816 are complete. If, on the other hand, in operation 820 the DTE determines that a transfer among the transfers initiated in operation 814 or operation 816 is not complete or, the DTE can repeat operation 818 to continue to monitor completion status of the transfer(s).

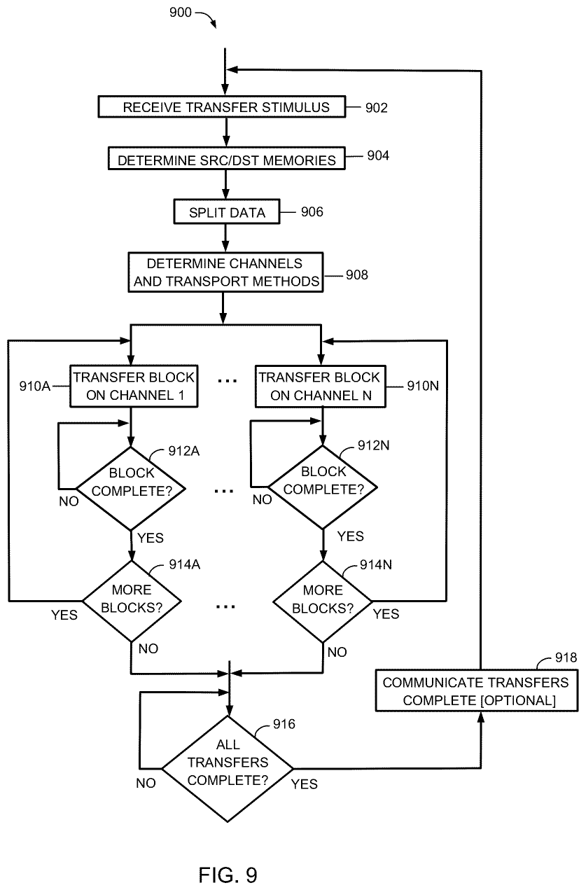

FIG. 9 illustrates an example method for a DTE to utilize multiple channels and transport methods to preform parallel transfer of stage data using multiple transfer channels of CGR hardware. To illustrate method 900 in FIG. 9, the method 900 is described continuing the example of the DTE and CGRS of method 800 of FIG. 8 to perform method 900. However, it will be appreciated by one of ordinary skill in the art that the method can apply to, be performed by, and/or utilize, a variety of components of a computing system (e.g., a dataflow computing system) alternative to these examples.

In operation 902, similar to operation 802 of method 800, the DTE receives a transfer stimulus. The transfer stimulus can comprise a transfer stimulus such as those described in operation 802 of method 800. In operation 904, similar to operation 804 of method 800, the DTE determines one or more source and destination memories associated with, or to perform, the transfer associated with the transfer stimulus received in operation 902. The DTE can determine the source and/or destination memories, in operation 904, in a manner similar to the manner of operation 804 of method 800 to determine the source and/or destination memories.

In operation 906 the DTE splits stage data, associated with the transfer stimulus received in operation 902, into a number of blocks of data, among the stage data, that can optimize (e.g., most efficiently) transfer of the stage data between the source and destination memories. In operation 908, the DTE determines that CGR hardware of the CGRS can transfer the blocks using multiple transfer channels, and determines “N” number of particular channels and accompanying transport methods using those channels, to transfer the blocks. The DTE can determine, in operation 908, the particular channels and/or transport methods in a manner similar to the manner of operation 806 of method 800 to determine particular channels and transport methods.

In operations 910A-910N, the DTE initiates transfer of a respective block, among the blocks determined in operation 906, on a channel, and using a transport method, among the N channels determined in operation 908. In operations 910A-910N, the DTE can initiate the transfers in a manner similar to the manner of operation 814 of method 800 to initiate transfers using multiple transfer channels and accompanying transport methods.

In operations 912A-912N, the DTE monitors transfers, using respective channels among the N channels, to determine if a respective transfer has completed. In operations 912A-912N, the DTE can monitor the transfers in a manner similar to the manner of operations 818 and 820 of method 800 to monitor status of a transfer and determine completion of the transfer.

If the DTE determines in an operation, among operations 912A-912N, that a respective transfer, among the N block transfers, has not completed, the DTE repeats the respective operation among operations 912A-912N. If the DTE determines, in an operation among operations 912A-912N, that a respective transfer has completed, in a respective operation among operations 914A-914N, the DTE determines if there are additional blocks, among the blocks determined in operation 906, that can be transferred using the transfer channel having just completed the respective transfer. If so, the DTE repeats the operations among the respective operations among operations 910A-910N, operations 912A-912N, and operations 914A-914N.

If the DTE determines, in an operation among operations 914A-914N, that there are no additional blocks, among the blocks determined in operation 906, to transfer or. alternatively that cannot be transferred using the transfer channel having just completed the respective transfer, in operation 916 the DTE determines if all blocks determined in operation 906 have been transferred between the source and destination memories. In operation 916 the DTE can determine that all blocks have been transferred (that is, all transfers among the transfers initiated in operations 910A-910N have completed, for all blocks determined in operation 906) in a manner similar to that of operation 820 of method 800 in FIG. 8. If the DTE determines, in operation 916, that not all blocks have been transferred, the DTE can repeat operation 916 (and, operations among operations 910A-910N, 912A-912N, and operations 914A-914N, needed to transfer all of the blocks using channels among the N channels).

If, alternatively, the DTE determines in operation 916 that all blocks have been transferred between the source and destination memories, the DTE can repeat operations 902-918 pending and in response to another transfer stimulus. In operation 918 the DTE can operationally, communicate that all of the stage data associated with the transfer stimulus received in operation 902 has been transferred between the source and destination memories. The DTE can perform operation 918, for example, in a manner similar to operation 822 of method 800 in FIG. 8.

The example of FIG. 9 particularly illustrates performing method 900 by a DTE utilizing more than a single channel (N>1). However, this is to illustrate the method and not intended to limit implementations. One of ordinary skill in the art will understand that a DTE can perform method 900 utilizing only one channel (N=1) and will appreciate modifications of method 900 to utilize a single channel.

Implementations can comprise a computer program product and can include a computer readable storage medium (or media) having computer readable program instructions of the computer program product incorporated therein. It will be understood by one of ordinary skill in the art that computer readable program instructions can implement each or any combination of operations and/or structure of the disclosure, such as illustrated by the drawings and described herein.

The computer readable program instructions can be provided to one or more processors, and/or other elements, of a computing system or apparatus to produce a machine which can execute, via the processor(s), to implement operations and/or actions similar or equivalent to those of the disclosure. The computer readable program instructions can be stored in a computer readable storage medium that can direct one or more processors, and/or other elements, of a computing system or apparatus to function in a particular manner, such that the computer readable storage medium comprises an article of manufacture including instructions to implement operations and/or structures similar or equivalent to those of the disclosure.

The computer readable program instructions of the computer program product can cause one or more processors to perform operations of the disclosure. A sequence of program instructions, and/or an assembly of one or more interrelated programming modules, of the computer program product can direct one or more one or more processors and/or computing elements of a computing system to implement the elements and/or operations of the disclosure including, but not limited to, the structures and operations illustrated and/or described in the present disclosure.

A computer readable storage medium can comprise any tangible (e.g., hardware) device, or combination of tangible devices, that can store instructions of the computer program product and that can be read by a computing element to download the instructions for use by a processor. A computer readable storage medium can comprise, but is not limited to, electronic, magnetic, optical, electromagnetic, and/or semiconductor storage devices, or any combination of these. A computer readable storage medium can comprise a portable storage medium, such as a magnetic disk/diskette, optical disk (CD or DVD); a volatile and/or non-volatile memory; a memory stick, a mechanically encoded device, and any combination of these. A computer readable storage medium, as used herein, is not to be construed as being transitory signals per se, such as electrical signals transmitted through a wire, radio waves or other freely propagating electromagnetic waves, or electromagnetic waves propagating through a wave transmission medium (e.g., a wave guide or fiber-optic cable).

The computer readable program instructions can be communicated from the computer readable storage medium to the one or more computing/processing devices, via a programming API of a computing system, and/or a communications interface of a computing system, having access to the computer readable storage medium, and/or a programming API of a computing system, and/or a communications interface of the one or more computing/processing devices. The API(s) and/or communications interface(s) can couple communicatively and/or operatively to a network, such as the Internet, a local area network, a wide area network, and/or a wireless network. The API(s) and/or communications interface(s) can receive the computer readable program instructions read from computer readable storage medium and can forward the computer readable program instructions to the one or more computing/processing devices via the API(s), communications interface(s), and/or network.

In implementations, the computer readable program instructions of the computer program product can comprise machine language and/or assembly language instructions, instruction-set-architecture (ISA) instructions, microcode and/or firmware instructions, state-setting data, configuration data for integrated circuitry, source code, and/or object code. The instructions and/or data can be written in any combination of one or more programming languages.

The computer readable program instructions can execute entirely, or in part, on a user's computer, as a stand-alone software package; partly on a user's computer and partly on a remote computer; or, entirely on a remote computer. A remote computer can be connected to a user's computer through any type of network, including a local area network (LAN) or a wide area network (WAN). In implementations, electronic circuitry including, for example, FPGA, PLAs, and or CGRPs can execute the computer readable program instructions by utilizing state information of the computer readable program instructions to configure the electronic circuitry to perform operations or elements of the disclosure, such as illustrated by the drawings and described herein.

In implementations, computer readable program instructions can also be loaded onto a computing system, or component(s) thereof, to cause the computing system and/or component(s) thereof to perform a series of operational steps to produce a computer implemented process, such that the instructions which execute on the computing system, or component(s) thereof, implement the operations or elements of the disclosure, such as illustrated by the drawings and described herein.

The flowchart and block diagrams in the Drawings and Incorporations illustrate the architecture, functionality, and operation of possible implementations of systems, methods, and computer program products according to various implementations. Individual elements illustrated in the Figures—such as individual operations illustrated in the flowcharts or individual blocks of block diagrams—may represent a module, segment, or portion of executable instructions for implementing the disclosed function(s). In various alternative implementations, particular operations may occur in an order differing from that illustrated in the examples of the drawings. For example, two operations shown in succession in a diagram of the disclosure may, in a particular implementation, be executed substantially concurrently, or may sometimes be executed in a reverse order, depending upon the functionality involved. It will be further noted that particular blocks of the block diagrams, operations of the flowchart illustrations, and/or combinations of blocks in the block diagrams and/or flowchart illustrations, can be implemented using special purpose hardware and/or systems that, individually or in combination, perform the specified functions, acts, and/or computer instructions.

Terminology used herein, and the examples disclosed, are chosen to illustrate the principles of the implementations, the practical application or technical improvement over alternative technologies, and to enable others of ordinary skill in the art to understand the implementations disclosed herein. The disclosure illustrates various example implementations, and the examples are intended to illustrate principles and aspects of the disclosure, but are not intended to limit implementations, nor intended to be exhaustive of implementations that may be conceived within the scope of the disclosure. It would be apparent to one of ordinary skill in the art that alternative implementations can comprise modifications and combinations within the spirit of the disclosure and the scope of the claims.

As can be seen in the foregoing examples, features of the disclosure can comprise methods and apparati of computing systems. A summary of example implementations of such features includes:

### Example Implementation 1

A method comprises: detecting, by an Intelligent Data Conversion Engine (IDC engine), a stage transition of a dataflow application executing on a dataflow computing system, the dataflow application comprising a plurality of application stages, the IDC engine included in the dataflow computing system, the dataflow computing system comprising a plurality of processing units; determining, by the IDC engine, responsive to the detecting the stage transition, that data among first stage data has a first Stage Data Format (SDF), the first stage data comprising data associated with a first stage among the plurality of application stages; determining, by the IDC engine, responsive to the detecting the stage transition, that a first processing unit, among the plurality of processing units, can process stage data having a second SDF; determining, by the IDC engine, responsive to the IDC engine determining that the first processing unit can process stage data having the second SDF, a first data conversion to convert the data among the first stage data having the first SDF to have the second SDF; determining, by the IDC engine, a second processing unit, among the plurality of processing units, to perform the first data conversion; and, dispatching, by the IDC engine, the second processing unit to perform the first data conversion.

### Example Implementation 2

The example of implementation 1, the method further comprising: determining, by the IDC engine, responsive to the detecting the stage transition, that the first processing unit can process stage data having a third SDF; determining, by the IDC engine, responsive to the IDC engine determining that the first processing unit can process stage data having the third SDF, a second data conversion to convert the data among the first stage data having the first SDF to have the third SDF; determining, by the IDC engine, a third processing unit, among the plurality of processing units, to convert the data among the first stage data having the first SDF to have the third SDF; and, comparing, by the IDC engine, a first conversion optimization metric, associated with the second processing unit performing the first data conversion, and a second conversion optimization metric, associated with the third processing unit performing the second data conversion. The method of the IDC engine dispatching the second processing unit to perform the first data conversion comprises the IDC engine dispatching the second processing unit to perform the first data conversion based on the comparing the first conversion optimization metric and the second conversion optimization metric.

### Example Implementation 3

The example of implementation 1, the method further comprising: determining, by the IDC engine, that the first data conversion comprises a sequence of intermediate data conversions; determining, by the IDC engine, a third processing unit, among the plurality of processing units, to perform a first intermediate data conversion included in the sequence of intermediate data conversions; determining, by the IDC engine, a fourth processing unit, among the plurality of processing units, to perform a second intermediate data conversion included in the sequence of intermediate data conversions; determining, by the IDC engine, a conversion order, the conversion order comprising an order, within the sequence of intermediate data conversions, for the third processing unit to perform the first intermediate data conversion and the fourth processing unit to perform the second intermediate data conversion; and, dispatching, by the IDC engine, the third processing unit to perform the first intermediate data conversion and the fourth processing unit to perform the second intermediate data conversion according to the conversion order.

### Example Implementation 4

The example of implementation 3, wherein the IDC engine determining the conversion order comprises the IDC engine applying a conversion cost model to determine the third processing unit, the fourth processing unit, and the conversion order.

### Example Implementation 5

The example of implementation 1, wherein the stage transition is selected from a group consisting of: a transfer of data included among the first stage data; input of the first stage data for processing by the first processing unit; initiating execution of the first stage; initiating execution of a second stage of the dataflow application; initiating execution of the dataflow application by the first processing unit; and, initiating execution of the dataflow application by a second processing unit included in the dataflow computing system.

### Example Implementation 6

The example of implementation 1, wherein the plurality of processing units comprises heterogeneous processing units; and, wherein the second SDF is based on a type of the first processing unit.

### Example Implementation 7

The example of implementation 1, wherein the IDC engine determining the first data conversion comprises the IDC engine determining the first data conversion based on a conversion optimization metric.

### Example Implementation 8

A computer program product comprises a computer readable storage medium having first program instructions embodied therewith, wherein the first program instructions are executable by at least one processor to cause the at least one processor to:

detect a stage transition of a dataflow application executing on a dataflow computing system, the dataflow application comprising a plurality of application stages, the dataflow computing system comprising a plurality of processing units; determine, responsive to the detecting the stage transition, that data among first stage data has a first Stage Data Format (SDF), the first stage data comprising data associated with a first stage among the plurality of application stages; determine, responsive to the detecting the stage transition, that a first processing unit, among the plurality of processing units, can process stage data having a second SDF; determine, responsive to the determining that the first processing unit can process stage data having the second SDF, a first data conversion to convert the data among the first stage data having the first SDF to have the second SDF; determine a second processing unit, among the plurality of processing units, to perform the first data conversion; and, dispatch the second processing unit to perform the first data conversion.

### Example Implementation 9

The example of implementation 8, wherein the first program instructions are executable by at least one processor to further cause the at least one processor to: determine, responsive to the detecting the stage transition, that the first processing unit can process stage data having a third SDF; determine, responsive to the determining that the first processing unit can process stage data having the third SDF, a second data conversion to convert the data among the first stage data having the first SDF to have the third SDF; determine a third processing unit, among the plurality of processing units, to convert the data among the first stage data having the first SDF to have the third SDF; and, compare a first conversion optimization metric, associated with the second processing unit performing the first data conversion, and a second conversion optimization metric, associated with the third processing unit performing the second data conversion. The dispatching the second processing unit to perform the first data conversion comprises dispatching the second processing unit to perform the first data conversion based on the comparing the first conversion optimization metric and the second conversion optimization metric.

### Example Implementation 10

The example of implementation 8, wherein the first program instructions are executable by at least one processor to further cause the at least one processor to: determine that the first data conversion comprises a sequence of intermediate data conversions; determine a third processing unit, among the plurality of processing units, to perform a first intermediate data conversion included in the sequence of intermediate data conversions; determine a fourth processing unit, among the plurality of processing units, to perform a second intermediate data conversion included in the sequence of intermediate data conversions; determine a conversion order, the conversion order comprising an order, within the sequence of intermediate data conversions, for the third processing unit to perform the first intermediate data conversion and the fourth processing unit to perform the second intermediate data conversion; and, dispatch the third processing unit to perform the first intermediate data conversion and the fourth processing unit to perform the second intermediate data conversion according to the conversion order.

### Example Implementation 11

A computing system comprises a plurality of processing units; a dataflow application comprising a plurality of application stages; and, an Intelligent Data Conversion Engine (IDC engine), the IDC engine configured to:

detect a stage transition of the dataflow application executing on the computing system; determine, responsive to the detecting the stage transition, that data among first stage data has a first Stage Data Format (SDF), the first stage data comprising data associated with a first stage among the plurality of application stages; determine, responsive to the detecting the stage transition, that a first processing unit, among the plurality of processing units, can process stage data having a second SDF; determine, responsive to the determining that the first processing unit can process stage data having the second SDF, a first data conversion to convert the data among the first stage data having the first SDF to have the second SDF; determine a second processing unit, among the plurality of processing units, to perform the first data conversion; and, dispatch the second processing unit to perform the first data conversion.

### Example Implementation 12

The example of implementation 11, wherein the IDC engine is further configured to:

determine, responsive to the detecting the stage transition, that the first processing unit can process stage data having a third SDF; determine, responsive to the IDC engine determining that the first processing unit can process stage data having the third SDF, a second data conversion to convert the data among the first stage data having the first SDF to have the third SDF; determine a third processing unit, among the plurality of processing units, to convert the data among the first stage data having the first SDF to have the third SDF; and, compare a first conversion optimization metric, associated with the second processing unit performing the first data conversion, and a second conversion optimization metric, associated with the third processing unit performing the second data conversion; and, wherein the IDC engine configured to dispatch the second processing unit to perform the first data conversion comprises the IDC engine further configured to dispatch the second processing unit to perform the first data conversion based on the comparing the first conversion optimization metric and the second conversion optimization metric.

### Example Implementation 13

The example of implementation 11, wherein the IDC engine is further configured to:

determine that the first data conversion comprises a sequence of intermediate data conversions; determine a third processing unit, among the plurality of processing units, to perform a first intermediate data conversion included in the sequence of intermediate data conversions; determine a fourth processing unit, among the plurality of processing units, to perform a second intermediate data conversion included in the sequence of intermediate data conversions; determine a conversion order, the conversion order comprising an order, within the sequence of intermediate data conversions, for the third processing unit to perform the first intermediate data conversion and the fourth processing unit to perform the second intermediate data conversion; and, dispatch the third processing unit to perform the first intermediate data conversion and the fourth processing unit to perform the second intermediate data conversion according to the conversion order.

### Example Implementation 14

The example of implementation 13, wherein the IDC engine configured to determine the conversion order comprises the IDC engine further configured to apply a conversion cost model to determine the third processing unit, the fourth processing unit, and the conversion order.

### Example Implementation 15

The example of implementation 11, wherein the stage transition is selected from a group consisting of: a transfer of data included among the first stage data; input of the first stage data for processing by the first processing unit; initiating execution of the first stage; initiating execution of a second stage of the dataflow application; initiating execution of the dataflow application by the first processing unit; and, initiating execution of the dataflow application by a second processing unit among the plurality of processing units.

### Example Implementation 16

The example of implementation 11, wherein the plurality of processing units comprises heterogeneous processing units; and, wherein the second SDF is based on a type of the first processing unit.

### Example Implementation 17

The example of implementation 11, wherein the IDC engine configured to determine the first data conversion comprises the IDC engine further configured to determine the first data conversion based on a conversion optimization metric.

### Example Implementation 18

The example of implementation 11, wherein the first processing unit is selected from a group consisting of: a general purpose central processing unit (CPU); a graphic processing unit (GPU); and, a coarse grain reconfigurable processor (CGRP).

### Example Implementation 19

The example of implementation 11, the computing system further comprising a runtime processor configured to execute the dataflow application on the computing system; wherein the IDC engine is communicatively coupled to the runtime processor; and, wherein the IDC engine is further configured to interact with the runtime processor perform at least one of the detecting the stage transition and the dispatching the second processing unit to perform the first data conversion.

### Example Implementation 20

The example of implementation 19, wherein the IDC engine is included in the runtime processor.

What is claimed is:

1. A method, the method comprising:
detecting, by an Intelligent Data Conversion Engine (IDC engine), a stage transition of a dataflow application executing on a dataflow computing system, the dataflow application comprising a plurality of application stages, the IDC engine included in the dataflow computing system, the dataflow computing system comprising a plurality of processing units;
determining, by the IDC engine, responsive to the detecting the stage transition, that data among first stage data has a first Stage Data Format (SDF), the first stage data comprising data associated with a first stage among the plurality of application stages;
determining, by the IDC engine, responsive to the detecting the stage transition, that a first processing unit, among the plurality of processing units, can process stage data having a second SDF;
determining, by the IDC engine, responsive to the IDC engine determining that the first processing unit can process stage data having the second SDF, a first data conversion to convert the data among the first stage data having the first SDF to have the second SDF;
determining, by the IDC engine, a second processing unit, among the plurality of processing units, to perform the first data conversion; and,
dispatching, by the IDC engine, the second processing unit to perform the first data conversion.

2. The method of claim 1, the method further comprising:
determining, by the IDC engine, responsive to the detecting the stage transition, that the first processing unit can process stage data having a third SDF;
determining, by the IDC engine, responsive to the IDC engine determining that the first processing unit can process stage data having the third SDF, a second data conversion to convert the data among the first stage data having the first SDF to have the third SDF;
determining, by the IDC engine, a third processing unit, among the plurality of processing units, to convert the data among the first stage data having the first SDF to have the third SDF; and,
comparing, by the IDC engine, a first conversion optimization metric, associated with the second processing unit performing the first data conversion, and a second conversion optimization metric, associated with the third processing unit performing the second data conversion; and,
wherein the method of the IDC engine dispatching the second processing unit to perform the first data conversion comprises the IDC engine dispatching the second processing unit to perform the first data conversion based on the comparing the first conversion optimization metric and the second conversion optimization metric.

3. The method of claim 1, the method further comprising:
determining, by the IDC engine, that the first data conversion comprises a sequence of intermediate data conversions;
determining, by the IDC engine, a third processing unit, among the plurality of processing units, to perform a first intermediate data conversion included in the sequence of intermediate data conversions;
determining, by the IDC engine, a fourth processing unit, among the plurality of processing units, to perform a second intermediate data conversion included in the sequence of intermediate data conversions;
determining, by the IDC engine, a conversion order, the conversion order comprising an order, within the sequence of intermediate data conversions, for the third processing unit to perform the first intermediate data conversion and the fourth processing unit to perform the second intermediate data conversion; and,
dispatching, by the IDC engine, the third processing unit to perform the first intermediate data conversion and the fourth processing unit to perform the second intermediate data conversion according to the conversion order.

4. The method of claim 3, wherein the IDC engine determining the conversion order comprises the IDC engine applying a conversion cost model to determine the third processing unit, the fourth processing unit, and the conversion order.

5. The method of claim 1, wherein the stage transition is selected from a group consisting of: a transfer of data included among the first stage data; input of the first stage data for processing by the first processing unit; initiating execution of the first stage; initiating execution of a second stage of the dataflow application; initiating execution of the dataflow application by the first processing unit; and, initiating execution of the dataflow application by a second processing unit included in the dataflow computing system.

6. The method of claim 1, wherein the plurality of processing units comprises heterogeneous processing units; and, wherein the second SDF is based on a type of the first processing unit.

7. The method of claim 1, wherein the DC engine determining the first data conversion comprises the DC engine determining the first data conversion based on a conversion optimization metric.

8. A computer program product, the computer program product comprising a computer readable storage medium having first program instructions embodied therewith, wherein the first program instructions are executable by at least one processor to cause the at least one processor to:
detect a stage transition of a dataflow application executing on a dataflow computing system, the dataflow application comprising a plurality of application stages, the dataflow computing system comprising a plurality of processing units;
determine, responsive to the detecting the stage transition, that data among first stage data has a first Stage Data Format (SDF), the first stage data comprising data associated with a first stage among the plurality of application stages;
determine, responsive to the detecting the stage transition, that a first processing unit, among the plurality of processing units, can process stage data having a second SDF;
determine, responsive to the determining that the first processing unit can process stage data having the second SDF, a first data conversion to convert the data among the first stage data having the first SDF to have the second SDF;
determine a second processing unit, among the plurality of processing units, to perform the first data conversion; and,
dispatch the second processing unit to perform the first data conversion.

9. The computer program product of claim 8, wherein the first program instructions are executable by at least one processor to further cause the at least one processor to:
determine, responsive to the detecting the stage transition, that the first processing unit can process stage data having a third SDF;
determine, responsive to the determining that the first processing unit can process stage data having the third SDF, a second data conversion to convert the data among the first stage data having the first SDF to have the third SDF;
determine a third processing unit, among the plurality of processing units, to convert the data among the first stage data having the first SDF to have the third SDF; and,
compare a first conversion optimization metric, associated with the second processing unit performing the first data conversion, and a second conversion optimization metric, associated with the third processing unit performing the second data conversion; and,
wherein the dispatching the second processing unit to perform the first data conversion comprises dispatching the second processing unit to perform the first data conversion based on the comparing the first conversion optimization metric and the second conversion optimization metric.

10. The computer program product of claim 8, wherein the first program instructions are executable by at least one processor to further cause the at least one processor to:
determine that the first data conversion comprises a sequence of intermediate data conversions;
determine a third processing unit, among the plurality of processing units, to perform a first intermediate data conversion included in the sequence of intermediate data conversions;
determine a fourth processing unit, among the plurality of processing units, to perform a second intermediate data conversion included in the sequence of intermediate data conversions;
determine a conversion order, the conversion order comprising an order, within the sequence of intermediate data conversions, for the third processing unit to perform the first intermediate data conversion and the fourth processing unit to perform the second intermediate data conversion; and,
dispatch the third processing unit to perform the first intermediate data conversion and the fourth processing unit to perform the second intermediate data conversion according to the conversion order.

11. A computing system comprising:
a plurality of processing units;
a dataflow application comprising a plurality of application stages; and,
an Intelligent Data Conversion Engine (IDC engine), the IDC engine configured to:
detect a stage transition of the dataflow application executing on the computing system;
determine, responsive to the detecting the stage transition, that data among first stage data has a first Stage Data Format (SDF), the first stage data comprising data associated with a first stage among the plurality of application stages;
determine, responsive to the detecting the stage transition, that a first processing unit, among the plurality of processing units, can process stage data having a second SDF;
determine, responsive to the determining that the first processing unit can process stage data having the second SDF, a first data conversion to convert the data among the first stage data having the first SDF to have the second SDF;
determine a second processing unit, among the plurality of processing units, to perform the first data conversion; and,
dispatch the second processing unit to perform the first data conversion.

12. The computing system of claim 11, wherein the IDC engine is further configured to:
determine, responsive to the detecting the stage transition, that the first processing unit can process stage data having a third SDF;
determine, responsive to the IDC engine determining that the first processing unit can process stage data having the third SDF, a second data conversion to convert the data among the first stage data having the first SDF to have the third SDF;
determine a third processing unit, among the plurality of processing units, to convert the data among the first stage data having the first SDF to have the third SDF; and,
compare a first conversion optimization metric, associated with the second processing unit performing the first data conversion, and a second conversion optimization metric, associated with the third processing unit performing the second data conversion; and,
wherein the IDC engine configured to dispatch the second processing unit to perform the first data conversion comprises the IDC engine further configured to dispatch the second processing unit to perform the first data conversion based on the comparing the first conversion optimization metric and the second conversion optimization metric.

13. The computing system of claim 11, wherein the IDC engine is further configured to:
determine that the first data conversion comprises a sequence of intermediate data conversions;
determine a third processing unit, among the plurality of processing units, to perform a first intermediate data conversion included in the sequence of intermediate data conversions;
determine a fourth processing unit, among the plurality of processing units, to perform a second intermediate data conversion included in the sequence of intermediate data conversions;
determine a conversion order, the conversion order comprising an order, within the sequence of intermediate data conversions, for the third processing unit to perform the first intermediate data conversion and the fourth processing unit to perform the second intermediate data conversion; and,
dispatch the third processing unit to perform the first intermediate data conversion and the fourth processing unit to perform the second intermediate data conversion according to the conversion order.

14. The computing system of claim 13, wherein the IDC engine configured to determine the conversion order comprises the IDC engine further configured to apply a conversion cost model to determine the third processing unit, the fourth processing unit, and the conversion order.

15. The computing system of claim 11, wherein the stage transition is selected from a group consisting of: a transfer of data included among the first stage data; input of the first stage data for processing by the first processing unit; initiating execution of the first stage; initiating execution of a second stage of the dataflow application; initiating execution of the dataflow application by the first processing unit; and, initiating execution of the dataflow application by a second processing unit among the plurality of processing units.

16. The computing system of claim 11, wherein the plurality of processing units comprises heterogeneous processing units; and, wherein the second SDF is based on a type of the first processing unit.

17. The computing system of claim 11, wherein the IDC engine configured to determine the first data conversion comprises the IDC engine further configured to determine the first data conversion based on a conversion optimization metric.

18. The computing system of claim 11, wherein the first processing unit is selected from a group consisting of: a general purpose central processing unit (CPU); a graphic processing unit (GPU); and, a coarse grain reconfigurable processor (CGRP).

19. The computing system of claim 11, the computing system further comprising a runtime processor configured to execute the dataflow application on the computing system;
wherein the IDC engine is communicatively coupled to the runtime processor; and,
wherein the IDC engine is further configured to interact with the runtime processor perform at least one of the detecting the stage transition and the dispatching the second processing unit to perform the first data conversion.

20. The computing system of claim 19, wherein the IDC engine is included in the runtime processor.
